(19) United States
(12) Patent Application Publication
(10) Pub. No.: US 2008/0091692 A1
(43) Pub. Date: Apr. 17, 2008

(54) INFORMATION COLLECTION IN MULTI-PARTICIPANT ONLINE COMMUNITIES

(76) Inventors: Christopher Keith, New York, NY (US); David Renouf, Montreal (CA); Wilbur H. Highleyman, Blairstown, NJ (US)

Correspondence Address: RAUBVOGEL LAW OFFICE, 820 LAKEVIEW WAY, REDWOOD CITY, CA, 94062, US

(21) Appl. No.: 11/760,444

(22) Filed: Jun. 8, 2007

Related U.S. Application Data
(60) Provisional application No. 60/812,538, filed on Jun. 9, 2006.

(51) Int. Cl. G06F 7/00

(52) U.S. Cl. 707/100

(57) ABSTRACT

A database of personal information is built and controlled by the individual users creating it. This database can then be used to enhance the functionality and user experience associated with multi-participant online communities. By collecting information from users themselves, and by allowing users to maintain such data, the data can have significant added value both to the users and to any commercial services that wish to use it. Appropriate precautions are taken to ensure that users maintain control over the data they choose to share. Data is owned by the user that provided it, and any application or release of such data is only performed at user direction and under user control. The users are also given incentives to provide such data, in the form of promised rewards. These mechanisms improve the amount and quality of collected data, so that comprehensive databases describing users can be built more easily and effectively.

### CROSS-REFERENCE TO RELATED APPLICATION

This patent application claims priority from U.S. Provisional Application Ser. No. 60/812,538 for “Facilitating Communication Modes in Multi-Participant Online Communities”, filed Jun. 9, 2006, the disclosure of which is incorporated herein by reference.

### FIELD OF THE INVENTION

The present invention relates to multi-participant online communities, and more particularly to mechanisms for collecting user information and implementing virtual intelligence in the context of such communities.

### DESCRIPTION OF THE RELATED ART

Today, huge sums are spent by corporations buying data on people. This data is information that is collected through a variety of impersonal means. For example, it is well known to embed advertisements in search result pages, so as to present ads to those users that are most likely to be interested in them. As another example, it is well know to compile purchase history data for users of ecommerce websites, so as to gain insight into purchasing habits and preferences. It is also well known to tailor subscriptions, newsletters, electronically delivered periodicals, and the like, to specific interests associated with users.

Most such methodologies require information about the user, so as to effectively present customized data to users. Collecting sufficient information of the right type is a significant challenge.

Traditionally, it has been difficult to induce users to build databases about themselves. Users perceive such activity as labor-intensive and unrewarding. However, in some contexts, users are willing to build at least limited databases given proper motivation and adequate assurances of control. For example, users are often willing to provide information about themselves when they are joining a social network, because of the perceived value (to themselves) of providing such information.

One concern many users have is the sensitivity of the information they are considering providing. Users often feel that once they provide such information, they will lose control over how the information is used and distributed. Such concerns often inhibit users from sharing certain types of information.

Multi-participant online communities, which include virtual worlds or can refer to the Internet as a whole, provide an imaginary space in which avatars can move about, build, socialize, compete, live surrogate lives and so on. Some existing communities are designed to function primarily as MMORPGs (Massively Multiple On-Line Role Playing Games). Others are targeted toward other forms of games and learning. Still others focus on the virtual nature of the community and the activities available therein. Many such communities resemble chat-rooms with figurines (avatars).

What is needed is a mechanism that provides improved incentives to users for sharing personal data. What is further needed is a mechanism that provides users with increased assurance that they will maintain control over data they have elected to share. What is further needed is a technique that effectively collects user information in a multi-participant online community environment.

### SUMMARY OF THE INVENTION

According to the present invention, a database of personal information is built and controlled by the individual users creating it. This database can then be used to enhance the functionality and user experience associated with multi-participant online communities.

By collecting information from users themselves, and by allowing users to maintain such data, the data can have significant added value both to the users and to any commercial services that wish to use it.

Furthermore, the present invention provides assurances to users that they will maintain control over the data they choose to share. Data is owned by the user that provided it, and any application or release of such data is only performed at user direction and under user control. The users are also given incentives to provide such data, in the form of promised rewards. These mechanisms improve the amount and quality of collected data, so that comprehensive databases describing users can be built more easily and effectively.

In one embodiment, the techniques described herein are implemented in the context of a multi-participant online community. The present invention expands on the concept of a MMORPG to allow participants to meet new people and socialize, and to play roles that represent themselves. For example, the present invention provides functionality that allows users to attract the people they want to meet, and to access better information services, better shopping services, unique entertainment, and the like. A large, rich database of users (including demographics, backgrounds preferences, behavior, and more) can be collected and made available to marketers in a way entirely consistent with users' wishes.

However, one skilled in the art will recognize that these techniques can also be implemented in other contexts, such as communications among Internet users, and between users and Internet sites. Thus, the techniques of the present invention can be implemented in ordinary Internet websites, in chat rooms having enhanced functionality, and/or in special environments such as virtual worlds.

### BRIEF DESCRIPTION OF THE DRAWINGS

FIG. 1 is a conceptual diagram depicting the contrast between avatars as used in conventional online communities and the intelligent avatar of the present invention.

FIG. 2 is a screen shot depicting a chat room display as may be presented in the context of the present invention.

FIG. 3 is a screen shot depicting a chat control panel according to one embodiment.

FIG. 4 depicts an architecture for implementing chat rooms according to one embodiment of the present invention.

FIG. 5 depicts operation of a chat room server process according to one embodiment of the present invention.

FIG. 6 depicts an example of a detailed client system architecture for implementing the present invention according to one embodiment.

FIG. 7 depicts an example of toolbar according to one embodiment of the present invention.

FIG. 8 depicts an example of a website display according to one embodiment of the present invention.

FIG. 9 is an example of a screen shot for an online community showing affinity scores.

FIG. 10 depicts an example of another embodiment of a chat room display.

FIG. 11A depicts an example of a virtual city display according to one embodiment. FIG. 11B depicts an example of a district within the virtual city display according to one embodiment. FIG. 11C depicts an example of a street within the virtual city display according to one embodiment.

FIG. 12 depicts an example of a merchant monitor window according to one embodiment.

FIG. 13 depicts an example of a merchant monitor configuration window according to one embodiment.

FIG. 14 depicts an example of a filter editing window according to one embodiment.

### DETAILED DESCRIPTION OF THE EMBODIMENTS

For illustrative purposes, the invention is described herein in the context of a multi-participant online community such as a virtual world. One skilled in the art will recognize, however, that the techniques of the present invention can be implemented in many other contexts wherein a number of participants can communicate with one another in an online environment. Such contexts include, for example, a user group, a website, the Internet as a whole, a localized network, or the like.

Overview

In one embodiment, the present invention is implemented in an online community architecture where users can search out other users who have similar interests. Each user is associated with, or “owns”, one or more avatars. Users can initiate social contact with other users through their respective avatars. Enhanced functionality allows users to enjoy shopping services and other services based on their interests and preferences.

Each avatar has a social intelligence derived from an adaptive database. Initially, the database is populated by the avatar's owner. Thereafter, as the owner experiences interactions with virtual environments and other avatars, details of these interactions are recorded in a database record associated with the corresponding avatar. Thus, as the avatar gains experience, it becomes more knowledgeable, according to techniques described in more detail below.

In one embodiment, a “Wizard” is implemented to learn affinities among avatars. The Wizard is a software module that assists in analyzing and finding affinities among avatars. As such, it compares publicly available data of avatars to determine potential mutual interests. It notifies an avatar should it determine such an interest. The owners of the avatars can then engage in further socialization if they wish.

Using the avatar database, the Wizard can provide many additional functions to the user, such as personalized Internet services, selected current event reporting, and tailored shopping experiences, as described in more detail below. Such services can be personalized based on the avatar database to determine interests in different situations.

In one embodiment, an enhanced chat room is provided to implement a unique meeting environment for avatars and their owners. Such chat rooms provide both a structured conversation environment, for instance for classrooms, shopping tours, celebrity events (like a book signing), interaction with store clerks, and games. They also provide an unstructured environment for general socialization.

The enhanced chat rooms of the present invention provide ways for groups of people to interact in new ways as well. Typical Internet interactions today use either instant messaging (IM), in which users can type messages to each other in an uncontrolled manner, or video conferencing. IM does not work very well for groups of more than a very few people. Video conferencing requires a significant investment in equipment and network bandwidth. Neither provides a natural venue for social interaction between the participants.

Using the chat rooms of the present invention, a group of avatars can agree to meet for any purpose whatsoever—socialization, education, or business, for example. The chat rooms provide several conversational protocols for one-on-one chats, group meetings, or lectures. A white board is provided for presentations or for interactive drawings. A subgroup of avatars in a chat room can agree to hold a private side chat while still listening to the main conversation.

In one embodiment, access to services is achieved via a toolbar that can be downloaded and installed as an add-in to the user's browser. The toolbar allows users to meet anywhere on the Internet, on any website, and their avatars can record their interactions with other users and with websites they visit.

The tool bar thus provides a mechanism for socializing, communicating, shopping, and getting information via the Internet. Using the toolbar, the user's avatar becomes the alter ego of its user, exhibiting its user's attributes, history, and interests.

Using the avatar databases, the system of the present invention can provide extremely valuable information to merchants and to advertisers concerning the attributes of the people visiting their websites. For example, such information can indicate the identity of those individuals who are visiting their Web sites, the visitors' interests and transaction history, and how the merchants' online stores are doing competitively.

In addition, a site operator can use the provided visitor data to convert site visitors to customers, for example by engaging them in chats and providing them with offers customized to their interests. Site operators are also provided a more finely tuned methodology for targeting their advertising.

In one embodiment, avatars can enter other virtual worlds and even interact with established online communities such as Second Life. Services can be implemented in a highly portable programming language and environment such as Java, so as to facilitate portability of functionality.

Each of the above-described concepts can be implemented singly or in combination, as will be described in more detail below.

Avatar

The term ‘avatar’ has come to mean an icon in computer games that represents a user. In these games, commonly called Massively Multiplayer Online Role-Playing Games (MMORPGs), an avatar may or may not carry special equipment and powers; it is essentially a visual representation.

According to one embodiment, an intelligent avatar is implemented, so as to maximize the value of the personal data that the user has provided in his or her database. In the context of the present invention, an avatar thus represents a user but in a more encompassing way. The avatar may or may not be active as a physical representation. It may also represent the user as a database entry or entries and as a set of special behavioral attributes, taught or innate. An avatar generally behaves as directed but not necessarily invariably. It can remember the past, and it can exhibit reactions and feelings of its own. Each avatar is therefore potentially a representation of a “bot” (automated agent) that is capable of being driven by an independent program. The independent program is in turn controlled by user signals. In one embodiment, the user does not have to move or control the avatar directly. The user directs the avatar to move itself.

The present invention implements an intelligent avatar having one or more levels of social intelligence, such as for example:
the ability to interact with its environment based on similarities found between the environment and its own database
the ability to interact with its environment based on behavioral attributes

During these interactions, the avatar can add experiences to its database and thus “learn” in the process.

Avatars can receive integrated instructions (signals) sent from a user interface directed by the user; these instructions invoke predefined atomic behaviors. Such behaviors can include, for example, gestures, emotions avatar facial gestures, body motion, dialogue, and the like, and can be implemented using decision tables (IF statement arranged), JavaScript, and/or other techniques. One behavior might combine the following actions: body=hand to head; facial expression; astonished 3; verbal; “who would have believed it?” Each avatar can be taught an indefinite number of integrated gestures, facial expressions, dialogues, and the like, either individually or as part of behaviors. The expressions and behaviors can be added to an avatar's inventory and summoned by the user with a single click. Behaviors can be arranged into behavior palettes and summoned as palettes (like toolbars) for easy access and activation. Behaviors can be linked so that behavior M activates a successor, for example behavior J; thus, the present invention enables combinations of behaviors that can themselves be treated as behaviors.

In one embodiment, each avatar can read the signals sent by other avatars, which can be transmitted to the user and used as input to adjust avatar behavior.

Avatars can be operated in manual mode and/or in semi-automatic mode (“cruising”), choosing behaviors or combinations of behaviors on its own depending on signals received. Avatars can thus be taught to read and adjust to the actions and moods of other avatars (for example, to act appropriately during the telling of a funny story, an amazing story, a depressing story) and detect subtle behavior differences in other avatars. In one embodiment, avatars provide functions for starting and entering interactions, and special interactive facilities for engaging in conversations, making introductions, and automatically exchanging acquaintance data.

An avatar can have multiple graphical representations that it can use in different virtual worlds. An avatar can express emotions and gestures. “Cruise programs” implement complex sequences of behaviors in response to user commands or to external stimuli.

According to the present invention each avatar can assume a form or no form, depending upon the environment. In either event, it is serving as an alter ego for its user. It represents its owner with its database of acquired knowledge and a set of skills, or intelligence. Thus, the avatar of the present invention is able to store and present information reflecting its owner, and can act of its own accord.

The avatar is able to store and express a great deal about the user it represents, at least to the extent that the user has divulged this information by entering it into the avatar's database. This information includes, for example, the user's background, interests, experience, and/or other items of a personal nature. The avatar can express emotions either dictated by its owner or in response to its environment, and other avatars can read these emotions. The avatar can react automatically in certain situations, and can otherwise be controlled by the person it represents.

The avatar has a memory and can remember which avatars it has met, what their conversations were, what were its attitudes towards other avatars, where it visited, and the like. To the extent that other avatars make their personal information available, the Wizard can seek out those other avatars by searching for affinities within whatever group it finds itself or over the avatar population as a whole.

All of this information is contained in a database private to the avatar. The user can designate which information is to be made publicly available to other avatars and which is to be private and divulged only upon command of the user.

The stored information is used to give the avatar a personality in social group settings, and can also enhance the user's learning experience in other settings.

In one embodiment, each avatar carries a certain status, or rank. A tourist is an anonymous avatar. A resident is an avatar whose identity has been confirmed by the operator of the online community. A confirmed resident is an avatar that has been verified by other members of a community to be a member of that community (for instance, he attended some university).

An avatar can also achieve certain levels based on the extensiveness of its database. As its level increases, so do certain privileges that it has. This encourages users to add personal information to their databases. It also rewards those users who are more active and have accumulated more experiences in their databases.

The avatar of the present invention is, therefore, like an alter ego of the user. It accompanies (and can represent) the user on his or her journeys through the Internet. It can assume a visible form appropriate to an environment. It can interact with the websites, resources, and other users. For instance, to a search engine, the avatar can provide a standardized package of information about the user's demographics and his current behavior that can result in a search that is far more effective and robust than would otherwise be available.

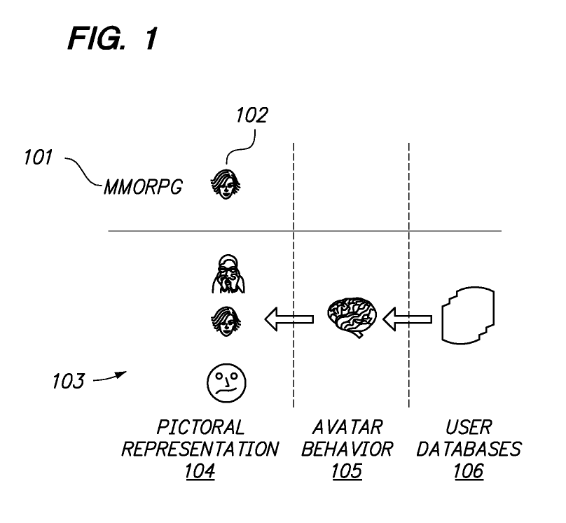

Referring now to FIG. 1, there is shown a conceptual depiction of the contrast between avatars as used in conventional online communities and the intelligent avatar of the present invention. A conventional avatar 101 includes a visual representation 102. An intelligent avatar 103 of the present invention includes any or all of:
any number of graphical or pictorial representations 104;
stored behavior components 105, also referred to as cruise programs which dictate actions that the avatar might automatically take in certain circumstances;
one or more user databases 106, which may contain the avatar's attributes and memory.

The present invention thus provides avatars that embody a collection of services tailored to the avatar's owner, encapsulated in the above three types of components.

Each of these will be discussed in turn.

Graphical Representations 104

An avatar can take on any one of many graphical representations. These representations are used, for example, in chat rooms. These include three-dimensional digital avatars, emoticons, still-picture sequences, video clips, live pictures, and the like.

In one embodiment, each avatar meets a predefined standard that specifies a set of gestures and emotions that can be expressed by the avatar. Gestures and emotions are used in various environments such as chat rooms. They can be invoked by the user as he desires, or they may be invoked automatically in response to some external stimulus.

When a user enters a chat room, his or her avatar enters the room on his or her behalf. The avatar is capable of generating a set of depictions, each of which has a standard identifying code. Avatar gestures and emotions are created by specifying a set of these depictions in a timed sequence. These timed sequences can be synchronized with the avatar's environment.

For example, an avatar can express emotions via facial expressions and gestures. An avatar's emotions are not only visible to the viewing participants, but they can also be made available to other avatars so that they can react automatically if desired. The current emotional state of an avatar is controlled by the avatar owner or, in some cases, automatically by its social intelligence.

In one embodiment, the physical representation of an avatar is an animated icon that can take any one of many forms supported.

For example, the avatar can be a two-dimensional or three-dimensional graphical representation, such as those representations 104 shown in FIG. 1. The participant can create his or her own avatar through any of several mechanisms:
By selecting from a set of basic digital avatars that can be modified to suit the preferences of the participant.
By generating a custom avatar via a graphical rendering package such as Poser (available from e frontier of Scotts Valley, Calif.), Autodesk 3ds Max or Maya (available from Autodesk, Inc. of San Rafael, Calif.), or SitePal (available from SitePal of New York, N.Y.).
By purchasing a custom avatar from an avatar renderer.

The present invention allows and facilitates presentation of emoticons. An emoticon is a simple rendering of emotion by showing simple facial expressions. Emoticons can be selected from an inventory of emoticons or can be provided by the user.

Other graphical representations can also be provided, including for example:
A defined set of photos of the participant, with each emotion being represented by a facial expression and an optional gesture rendered as a sequence of photos.
A series of video clips can be provided, each showing a particular gesture and emotion.
Live video from a video camera can be used to represent the avatar.
   Cruise Programs 105

Cruise programs are sequences of gestures and emotions that can be invoked either manually or automatically in response to some external stimulus. For instance, upon the entry to a group of another avatar known to a first avatar, the first avatar might automatically invoke a cruise program that causes his avatar to smile, wave, and say, “Hi, Charlie.”

Avatar Acquisition and Rank

To acquire an avatar, a user signs up. The user is prompted to provide some basic personal data. The user is given an opportunity to select an avatar appearance from one of the vendors who supply avatars. These avatars can be icons with a fixed expression, or they can be icons with a range of expressions and behaviors. The user can accept these icons which, with name tags, become unique as is, or he or she can accept them and modify them. An avatar so acquired not only has various gestures and expressions, but also has a behavioral style expressed in cruise programs. Therefore, a user can become an avatar operator very easily, and without cost.

In one embodiment, each avatar has a rank, or standing. Initially, an avatar is given a low rank, referred to as “tourist”. Over time, however, the avatar can attain higher ranks. An avatar's rank may increase, for example, depending on how much data the avatar has about its user and the degree to which the attributes of the user can be verified. Thus, a resident is an avatar whose identity has been confirmed by the operator of the online community, and a confirmed resident is an avatar that has been verified by other members of a community to be a member of that community (for instance, he graduated from some university).

Avatar rank allows other users to be able to judge the veracity of an avatar. Many users choose only to interact with and see specific subsets of avatars of a given rank. Avatars are given advantages proportional to their rank, motivating users to ascend through the ranking process by providing more data.

As shown in FIG. 1, an avatar can have several graphical representations 104 to suit different environments. When the avatar enters a virtual world, it assumes an appearance suitable for that world. The appropriate appearance is shown to other users in a particular chat room.

Avatar Intelligence

Using the avatar database, an avatar can be imbued with a wide range of innate behaviors that allow it to interact automatically with its environment. In essence, the avatar behaves in an intelligent manner and can react on its own to various environmental stimuli. The avatar's behavioral intelligence is driven by the contents of its database, in effect giving the avatar a unique personality.

For example, the avatar is aware of the public data of the other avatars in its group. Via the Wizard, it can seek affinity with other avatars that have similar backgrounds or interests. It can be notified of affinities determined by the Wizard. When others browse the avatar's use data and find affinities, can generate messages to indicate expressed interest in the avatar. The avatar then receives these messages and can initiate conversations with other avatars if desired.

It remembers avatars that it has previously met. It remembers personal details of those avatars as well as the details of conversations and other interactions such as games. This knowledge can be used in current interactions.

The Avatar can express emotions to other avatars based on user commands or based on triggers in the conversation as well as on past experience. It can read the emotions of other avatars. It can remember its attitude toward avatars that it has met in the past based on the experience of those meetings and can factor that into its responses.

In one embodiment, during its conversation with another avatar, a user's avatar can exchange social data, explore interests, arrange other meetings, and engage in any other type of social interaction. It can also exhibit automatic behaviors in response to stimuli from its environment. For instance, when a new avatar which it knows enters a group, it can automatically smile, wave, and send a “hello” message. If it is asked to join a side chat during a lecture, it can respond with “Thank you, but not now. How about later?” These automated responses can be triggered based on environment, events, user preferences and settings, or any combination thereof.

Automatic responses can significantly reduce the load on the user by precluding his having to manually respond to many situations that can be automatically handled. Of course, it is up to the avatar's owner how much behavior can or should be automated. In some embodiments, only limited (or no) automated behaviors are provided.

Avatars can also have “Internet intelligence”. They can track their owners' use of the Internet and can provide services based on past experience. For example, an avatar can keep a favorites list containing URLs, user names, and passwords of sites visited by the user. It might also note the pages that are most frequently visited on the site. With this information, the avatar can automatically log on the user to a selected site and perhaps even take him or her to a favorite page.

The user can describe selected sites in site notes and can provide keywords characterizing the site. With this information, the avatar can create a personal directory which can be searched for the existence of certain key words or phrases to reach sites of interest.

Based on the browsing activity of the user, the Wizard can infer certain interests and preferences of the user and enter these into the user's database.

Avatars can also have “Gaming intelligence”. They can be taught how to play games and can play these games with other avatars. Over time, the avatar can become more proficient at a game. It can remember games which it played, with whom it played, its strategies, and the game outcomes.

When a user employs the toolbar of the present invention (as described in more detail below), the avatar accompanies the user unseen. If the user has the Wizard service turned on, the avatar can find affinities with other users who may be at the same site. The avatar can also establish a kind of informational rapport with the site itself (or an operator of the site). Thus, by using an avatar, a user is not just looking at a site visually, but causing a behind-the-scenes match of interests versus capabilities to take place as well.

In one embodiment, the ability to find affinities and establish contact with sites is performed by the Wizard, as described elsewhere. The avatar can function as the enabling agent for these operations. Thus, if two users (avatars) are on the same site, the Wizard function evaluates their affinities. This could lead to socializing, which can take place in a chat room associated with the site. Thus, a user interested in buying a product at a website could spend time in the site's chat room in the hopes of meeting up with a friend or someone else with an affinity who might inform him or her about the product.

In one embodiment, the avatar contains innate social intelligence which allows it to interact automatically with other avatars and its environment in an automated way. The value of this is that it allows avatars to interact in a more human fashion without requiring users to be distracted by the need to micro-manage them.

In one embodiment, the avatar's graphical representations and cruise programs are also contained in database 106.

The avatar's personal data can be organized into privacy levels. Public data is available for anyone to see. Private data can only be disclosed with the owner's specific permission. Intermediate privacy levels can allow that data to be seen only by avatar's that meet attributes specified by the owner, such as close friends or acquaintances.

Thus, data is transmitted only at explicit user direction. A user can choose to do a search without the avatar and on a completely anonymous basis.

In one embodiment, the present invention provides functionality to motivate people to provide personal data by:
making it easy to enter data.
making the data safe and secure.
making the data valuable to the user in as many ways as possible
making adding data entertaining.

In one embodiment, all collected data continues to belong to the user that provided it, and is used only with the user's explicit consent. By enabling Wizard functionality in browsing, the user makes elements of his or her data available to Internet sites and other users in a way that is advantageous to the user. The user can always disable the Wizard in order to operate anonymously. In one embodiment, even when the Wizard makes data available to an outside party, it does not allow the outside party to read the entire data set; rather, it transmits a predefined subset to the other party. For example, if the user visits a luggage site, the Wizard may advise the site that this is a previous customer that has been in contact with a particular sales agent previously. The Wizard may also provide personal information indicating that the customer is a frequent traveler, female, two children, upscale, and between 40 and 50 years of age. It might also indicate this customer meets the store's definition of a probable VIP. This data does not compromise the user's anonymity, but it provides a basis for special service not otherwise available.

In one embodiment, the data in an user's database 106 comes from three sources:
Personal data entered by the user.
Experience data that is tracked via the toolbar and/or other plug-ins. This data records the experiences of the avatar, such as who it has met, what were its interactions with other avatars, what Web sites it has visited, and details concerning the pages on each Web site that it viewed.
Information obtained from the Web by the Wizard, which matches Web material to the users' interests.

A user's database is initially populated by the user. Each virtual experience can, at the user's option, be, automatically recorded in the database. As the user adds more personal data to the database and adds virtual experiences by using his or her avatar, the database becomes more and more valuable.

In one embodiment, databases 106 are structured to support heuristic searches. For instance, a search for “fisherman” would also find a match with “angler.”

Database 106

Database 106 gives an avatar a personality that provides the information necessary to search for affinities with other avatars, and for a variety of other services provided by the Wizard. Database 106 can be associated with an avatar and/or user, and holds all of the personal information that a user is willing to enter, as well as a record of all of his or her virtual experiences.

Among the data that can be included in the avatar database are:
avatar's identity.
general data about the avatar's owner (such as name, demographics, login and password, handle, and the like).
background—homes, jobs, schools, clubs, trips, hospitals, with dates for each.
friends and family: names, locations, and backgrounds.
skills: specific skills such as languages, music, painting, technical, and the like.
possessions: significant property and belongings.
interests: hobbies, sports, relaxation activities (can be inferred by the Wizard from Internet browsing).
information about other avatars that the avatar has met.
a record of conversations and encounters with other avatars.
photos: links to photo libraries prepared by or associated with the user.
physical data about the avatar: height, weight, sizes, other attributes.
status: whether the avatar is a tourist, a resident, or a confirmed resident of one or more authorized communities.
level: a level of proficiency earned by the avatar, determined, for example, by the extensiveness of its database.
transactions: online purchases and shopping interactions.
Internet history/activity: sites, usernames/passwords, pages visited.
toolbar records: coupons, diary, comments, email, and the like.
“looking for”: logical statements that define specific affinities of interest.
cruise programs: special avatar behavior sequences.
cognitive: special skills to control avatar behavior.
acquaintances: avatars that have been met in the past, and notes about those avatars.
experiences: a record of all virtual world experiences, such as chats with other avatars and the details of games played.
modes: avatar's privacy mode, as described in more detail below.
avatar representations: graphical appearances available for different virtual worlds.

In addition to its use in the environment described herein, such data can be linked to other virtual worlds to bring many of the services of the present invention to those worlds.

Data Structure

In one embodiment, the following data structure is used for database 106, although one skilled in the art will recognize that other data structures are possible.

Each element (line) of data is stored as though it were an event, in a form analogous to a programming object. The event format is referred to herein as a “vob” (event object). A vob is able to answer standardized questions about itself, as well as to accept more detail. For example, the data element can answer a question such as: “What are your time-place characteristics?” This capability facilitates discovery of similarities across data elements entered in a non-standard or evolving form.

Data Valuation

In one embodiment, the user can assign as many as three kinds of value to a given data vob:
Viewability
Computability
Weighting

Viewability allows the user to define at what level of relationship data from a given vob is made available to someone else. Typically, when two avatars meet, they swap acquaintance data. Each user can indicate what data should be made available at this level. Thus, a user might want others to know immediately that he is highly religious and plays the clarinet. These would get a code of 1 to indicate willingness to provide this in the acquaintance data swap.

Computability is the corollary to viewability, but applied to affinity computations. A given vob can be defined to be public (it can be used for affinity computations), or confidential (it can be used in affinity computations but only asymmetric ones).

Weighting is the relative importance the users put on the data. This value is used to weight affinity matches, and used by the Wizard in its reverse search process to determine items that might be of interest to the user. A data element may be marked by the user as private, making it ineligible for affinity computation, but given a high weight, informing the Wizard that the vob is of great importance.

Affinities

Heuristic Access

To support affinity searches and other services, in one embodiment database 106 is organized as a heuristic database. In one embodiment, the heuristic database is relatively unstructured. It comprises unstructured vobs (event objects) and keywords.

In one embodiment, keywords are used to supplement heuristic-based affinity matching. Examples are interests, skills, and possessions.

Vobs can be implemented as free-form text. Examples of vobs in the avatar database are transactions and virtual experiences such as avatar conversations.

In one embodiment, the heuristic database engine of the present invention operates on a user database to support affinity browsing and searching by the Wizard. Heuristic access is accomplished by a heuristic matching of keywords in the databases. For instance, the following represent heuristic matches:

| | | |
|---|---|---|
| fisherman | angler | fishing |
| cross-country skier | cross-county skiing | Nordic skiing |
| woodwork | carpentry | woodworking |
| German | Deutsch | |

Heuristic browsing involves choosing a keyword from one database, accessing a thesaurus to find all similar words, and then scanning the other database for any of these keywords.

Once a heuristic match is found, an affinity has been established. The value of this affinity has yet to be established, and the establishment of affinity scores is discussed later. However, once a significant affinity has been found, the vobs in the database can be scanned if desired to find further entries dealing with that particular affinity. Scanning would be done for all of the words in thesaurus.

Heuristic matching has many other uses in the context of the present invention. For instance, the Wizard can create periodic reports for a user showing the current events that might be of interest to him based on his friends, acquaintances, interests, needs, and other data specified by the user. The Wizard uses heuristic matching to find material for these reports based on a scan of the user's database.

Affinity Calculation

As the Wizard searches for and finds affinities between two avatars, it builds an affinity score. Different affinities have different weights which can be influenced by other affinities. In one embodiment, a user is notified of an affinity once the affinity score reaches a predefined threshold level, which may be user-specified. The user can then decide whether or not to approach the other avatar and engage in conversation.

Any of several algorithms can be used to determine affinity scores.

User-Assigned Affinity Values: As described above, a user may assign individual data items an affinity score to indicate which attributes are important him and which are not.

Rarity: The less common the affinity, the more it is valued. Rock climbing might have more value than hiking. Living in East Lemonade, Mont., would have a higher value than living in New York City. Rarity is established by the number of avatars expressing that particular heuristic attribute.

Thus, if both users read the New York Times, this affinity is most likely to be not as interesting to a user as a common readership of a less prominent publication. Initially, an atlas can be provided to approximate the rarity of locations. As the database builds, this initial approximation can be replaced by actual summary data based on actual avatars. Likewise, the rarity rankings for pastimes, interests, skills, and other avatar attributes will be built over time as the number of avatars increases.

Interaffinity Relationships: If two users are from a relatively obscure place, then this affinity would have a high value. If two users read a newspaper from an obscure place, this affinity would also have a high value. However, if both users were from the same obscure place and read a newspaper from the same obscure place, then reading the newspaper would have much less of an affinity value. Likewise, kayaking and seal hunting might normally have high affinity values. However, if two residents of a particular obscure place hunted seals and kayaked, these activities would have a much smaller affinity value if these were common pastimes of residents of the obscure place.

This introduces the concept of conditional probabilities. For instance, the probability that two randomly chosen avatars are from a particular obscure place might be 0.1%. The probability that two randomly chosen avatars read the newspaper from the same obscure place might by 0.05%. However, the probability that two avatars from the obscure place read the newspaper from the same obscure place might be 95%. Thus, the present invention takes into account the presence of conditional probabilities so as to avoid overemphasis on redundant similarities.

Sensitivity to Attribute Types: In some cases, the affinity algorithm may be a function of the type of attribute. For instance, the affinity value of skills, interests, and possessions may depend upon the rarity of the attribute value. Friends and family may be simple matches. Background may be a function of rarity and time coincidence. Demographics may not be important at all except for “looking for” attributes.

Notification of Affinities

When the Wizard finds an affinity of sufficiently high score, it sends a notification of that affinity to the avatar for which it was doing the affinity scan.

Searching and Browsing

There are two types of affinity scanning—searching and browsing.

Affinity Searching: The Wizard searches for affinities among the avatars in a chat room. Should it find an affinity for a first avatar with a second avatar, then it makes that affinity visible to the first avatar by displaying an indicator above the second avatar. This indicator is shown as a numeric category:

1—There is some affinity at a score greater than that specified by the user.

2—There is a high affinity. This typically includes other avatars that matched a “looking for” attribute.

By right-clicking on the second avatar, the first user can see the attributes that established the affinity.

In one embodiment, affinity searching is automatic. It takes place among the avatars in a group, and the Wizard notifies those avatars for whom it has determined an affinity with another avatar by displaying a numeric affinity indicator over the avatars determined to have an affinity. The avatar being notified can see the attributes which created the affinity by right-clicking on the indicated avatar.

Avatar Browsing: The Wizard can browse all avatars for an affinity with a first avatar, whether those avatars are online or not. Users who have not authorized this type of sharing of their data can have their avatars excluded from the search. If an affinity is found with a second avatar which is not in the same chat room, then an “expression of interest” message is sent to that avatar. The first avatar is notified of the attributes that established the affinity.

The notification and the expression of interest message include the other avatar's name, the affinity score, and the data that triggered the affinity.

An avatar can specify that it can be browsed only by avatars which have some specified minimum affinity with it.

Passive and Active Affinities

In one embodiment, two types of attribute fields are include in avatar database records. The user, in fact, has two types of attribute fields—passive fields and active fields.

Passive fields are attributes that are found in the database. In one embodiment, the first pass at affinity testing is to try to find matches between these fields in the databases of two avatars.

Active affinities are those contained in the “looking for” attributes section of the database, as described above. In one embodiment, the Wizard searches for active affinities after determining whether or not any passive affinities exist.

Active affinities are Boolean functions of various attributes. For instance, a user may have specified that he is looking for a woman in her 30's that lives in either Philadelphia or New York. The active affinity would be

sex=female and age <40 and age >30 and (Philadelphia or New York)

In one embodiment, active affinities override passive affinities. Assume user A has specified the above active affinity. If users A and B have an affinity score of 25, but B does not match A's active affinity, then so far as A is concerned, there is no affinity. His affinity score with B is zero. However, if B has not specified an active affinity, then so far as B is concerned, there is an affinity with a score of 25 with A.

Symmetric and Asymmetric Affinities

An avatar's search for affinity is based upon the data that another avatar has made public. However, in one embodiment, when doing an affinity search on behalf of avatar A, the Wizard can compare the public data of another avatar B with private and public data of avatar A, without disclosing the private data of avatar A.

If an affinity exists between the public data of two avatars, then each is informed of that affinity. This is a symmetric affinity.

However, if the Wizard finds an affinity between avatar B's public data and avatar A's private data, then only avatar A is informed of the affinity. Avatar B is not informed of the affinity because it cannot see the private data of avatar A. This is an asymmetric affinity.

In one embodiment, analysis of passive data always produces symmetric affinity scores before they are weighted. For example, if both avatars indicate that they play tennis, the resulting affinity score would be symmetric. If one avatar's owner indicates that tennis playing is a highly important trait, while the other does not, the similarity as indicated by the affinity score would be weighted differently for each avatar.

In one embodiment, active affinity searching is always asymmetric. Only the avatar that is looking is notified of the affinity.

Affinity Calculation

In one embodiment, the value of an avatar's affinity with another avatar can be represented as
Affinity= [symbol] (matchᵢ)(liklihoodᵢ)(user_importanceᵢ)

where the sum is taken over all of the attributes of the avatar and where

match(i) is 0 if there is no match on attribute i or is 1 if there is a match.

likelihood(i) is a factor that depends upon the rarity of the attribute.

user_importance(i) is the affinity value assigned to the attribute by the user.

The user can specify the value of an affinity that is of interest to him. He or she is not notified of affinities whose value is less than that specified.

Affinity Score Display

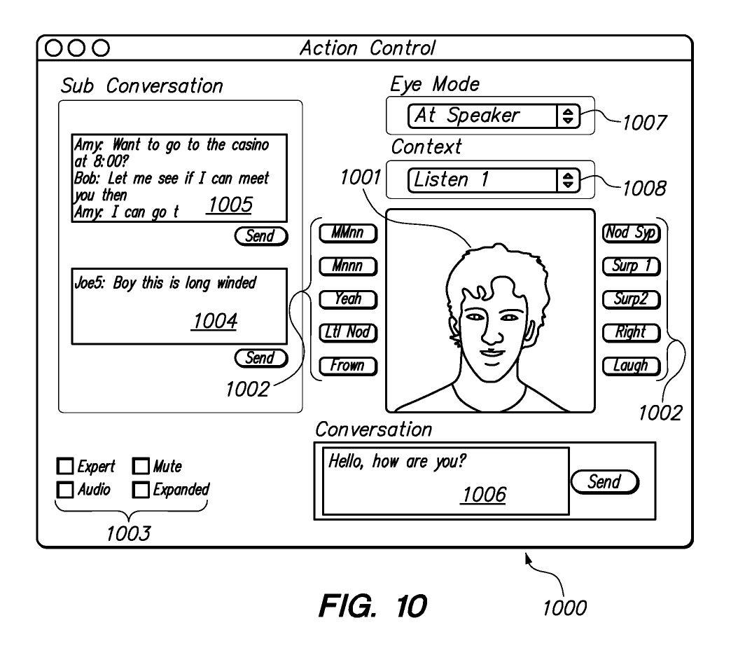

Referring now to FIG. 9, there is shown an example of an affinity score display. Screen shot 900 depicts a street scene environment 904 within an online community. Avatars 901 are shown within the street scene 904. For some or all avatars 901, an affinity score 902 is shown as a small circle.

Avatar 901A is a tourist who claims to be looking for someone who went to the user's school during a particular year, as shown in display area 905. The affinity sign of “?” 903A means that the user is aware that the tourist avatar 901A is looking for someone with those attributes (which match the user's attributes), but the tourist is not yet aware that the user fits them. Telling the tourist (or not) is up to the user.

Avatar 901B, with the affinity score 902B of “1”, is a fellow trainman that is aware that the user is an interested train hobbyist, as the user has indicated that on his disclosed goals list. In general, goals can be disclosed or undisclosed.

Additional Services

In one embodiment, other services can be supported in connection with the present invention. Some examples are described below. Many of these services encourage users to provide extensive personal databases, thus improving the robustness and effectiveness of the system. These avatar databases have tremendous commercial value for sales, for targeted marketing and for market research.

Internet Site Inference

The Internet site inference service records page URLs within online stores that the user has visited. From this information, user interests can be inferred and added to the user's database. For instance, if it is determined that the user is interested in small green cashmere sweaters, this interest can be added to the user's database.

In one embodiment, site operators can provide information concerning the contents of their pages, so as to improve the accuracy of this service.

Shopping Services

Professional shoppers can put together packages of web pages that contain quality items for a specific purpose. These can be searched by a user based on various parameters; the user can then be taken to specific pages on pertinent sites.

Online stores that cooperate with the professional shoppers create lists to provide the required information and to keep that information current. In return, the stores will have access to the public data of each shopping avatar, a tremendous source for instant marketing and market research. The stores may compensate the professional shopper with commissions.

Activity Diary

The avatar can maintain a diary of all virtual activities of its owner. These activities include the virtual universes visited, meetings with other avatars, the details of discussions, internet activity, and so on. The diary is organized so that it can be searched for a specific content. It becomes an important part of the avatar database, imbuing the avatar with memory.

Internet Wiki

In one embodiment, a wiki is supported for describing, classifying, and rating different web sites. The wiki can take the form of a collaborative encyclopedia with contributions from anyone who cares to write about a website or topic. It can be searched for a particular website, searched by keyword, or searched by attributes assigned by users.

In one embodiment, advertisements may be sold, to be placed on appropriate pages of the wiki.

Reports

The Wizard can use the personal data stored in the avatar database, such as the owner's interests and the people the avatar has met, to heuristically search for current information that might be of interest to the avatar's owner. This information might include people, events, products, and places and can come from news reports, web searches, and other sources.

The Wizard can periodically (such as daily or weekly) prepare a report for the user. The user can train this service by ranking items with respect to relevance to tune the report service over a period of time.

Services for Merchants

In addition to the above-described services for avatars, services can also be provided for merchants.

Wizard

In one embodiment a Wizard is implemented, which performs a variety of services for avatars based on the contents of the avatar databases. These services may or may not involve the use of the graphical representation of the avatar. They include, for example:
Determining affinities between avatars, and notifying each of discovered affinities with other avatars.
Interactive shopping services in which the user can communicate with a store clerk's avatar via his avatar.
Reports on current events of interest to the user.
Internet services for automatic logging on and inference of interests.
The receipt of marketing information for which the user has expressed an interest, such as new product announcements, special offers, and merchant auctions.

One skilled in the art will recognize that this list is merely exemplary, and that many other Wizard services can be implemented.

In some embodiments, Wizard functionality can be used to help set up social gatherings for groups of avatars with certain common attributes and to send invitations to those avatars to attend the gathering.

In one embodiment, a database engine is provided to allow a user to describe his or her personal data, what he or she wants to share about him- or herself, his or her preferences and the different goals he or she has. The user can indicate what information is seen in the three-dimensional viewer to what the user's goals and affinity are. In this manner, the present invention helps users to focus on what they are really looking for, highlight people that have a real high affinity score to those users in order to help narrow down and identify people with which contact would be beneficial. Pertinent data pertinent is stored in the avatar database as described above. When a user is interacting with the virtual online world, the avatar database can be continually searched Wizard can to identify best matches for that user, including people, products and things that match the user's profile and goals. The database engine can also continue to record interactions, and to make such recorded information available to enhance the experience and functionality of the system. The user is always in full control of what information gets recorded and what is revealed to others.

Enhanced Chat Rooms

In one embodiment, the present invention provides enhanced chat rooms that can be used for any purpose by a group of users. For instance, they can be used for social gatherings, for business meetings, or for educational purposes.

Chat rooms may be open, or they may be closed to all but those avatars with certain common attributes, such as those who are confirmed residents of a given community of users.

An enhanced chat room is a gathering place for intelligent avatars. In a chat room, a group of avatars can meet, socialize, listen to lectures, have business meetings, go on shopping tours, or do whatever else their owner counterparts might do in real life.

The avatars are shown together as a group in the chat room, generally with each looking at the current speaker. Avatars can be represented by digital avatars or by emoticons. Each avatar may perhaps be making pertinent gestures or expressing emotions, either under the control of the user or automatically in response to the actions of other avatars.

A chat room provides several conversation modes, or protocols, such as:
The chat mode/protocol, which allows several avatars to meet and converse in a controlled manner, with only one avatar at a time speaking (that is, typing text).
The hosted mode/protocol, which is a conversation that is controlled by a host—for instance, a lecturer.
The IM (instant messaging) mode/protocol, which allows avatars to all speak whenever they want. It is best suited for one-on-one conversations.

A picture area is provided for presentations. It can be used as a screen for video or slide presentations, or it can be used as a white board available to all users.

A subgroup of users in a chat room can agree to hold a side conversation, or side chat. Their conversation is private within the side chat, but they also hear the general conversation in the chat room (by “hear,” we mean that they see the text of the conversation). Subgroups do not hear the conversations of other subgroups.

A chat room can be resized to accommodate the size of the group meeting in that chat room. If there is not enough room for all of the avatars to be displayed, mechanisms may be provided for a user to specify which avatars he would like to see.

In one embodiment, the Wizard searches for affinities among the avatars in the chat room based on the personal data in their databases. Should it find an affinity, it notifies the pertinent avatar(s). At their discretion, the avatars can approach each other for a side chat or can agree to meet later in a chat room to socialize.

Though there are significant advantages to linking a chat room to the Wizard—such as the determination of affinities—there is no requirement to do so. If the Wizard is not included in the chat room, all of the functions of the chat room still exist except for the searching of affinities between avatars.

In one embodiment, the enhanced chat room is implemented in a portable programming language, such as Java, so that it can be easily migrated to other virtual worlds.

The chat room is populated by avatars. The avatar has social intelligence, as described elsewhere. It can express emotions and gestures either under the control of its owner or automatically in response to other avatars. If the chat room is linked to the Wizard, then avatars can be informed of affinities with each other, as described elsewhere. In one embodiment, an avatar is represented within a chat window as a series of frames representing the avatar in different positions. A gesture or emotion is displayed by showing a time sequence of pertinent frames.

Chat rooms are provided for meetings of groups of avatars. These meetings may be social gatherings, classrooms, focus groups, corporate meetings, marketing presentations, or any other kind of group in which avatars with common interests may gather. The chat rooms provide a variety of protocols for avatar interaction, as described herein.

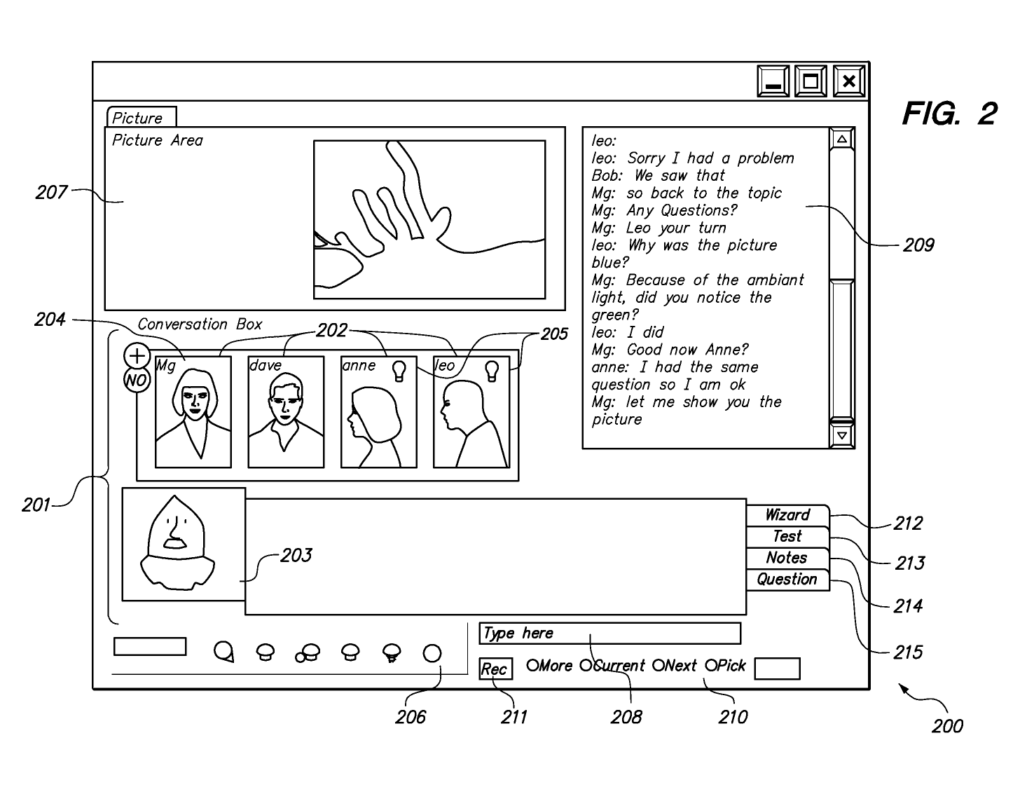

Referring now to FIG. 2, there is shown an example of a chat room display 200 as may be presented in the context of the present invention. In one embodiment, a chat room is presented to the participant as a set of panes. They can be positioned by the user according to his preferences. These panes are described below.

Conversation box 201 shows the avatars 202 of the participants in the group. Each participant's avatar 202 is identified with the participant's name. The viewing participant 203 (the participant who is looking at the group through his or her client system) normally sees himself or herself as a back view looking at the other participants (that is, a person does not see his or her own avatar except from the back). However, a mirror function allows the viewing participant to see his own avatar's expressions.

The viewing participant 203 appears in the auxiliary conversation pane below the conversation box and is shown looking at the group which he or she has joined in the conversation box.

The participant who is currently speaking is noted by green star 204. A participant who is requesting permission to speak (for instance, to ask a question) is noted by the light-bulb symbol 205.

If the Wizard determines an affinity between avatars 201, either or both will be notified by placing an indicator over the other avatar. This number is either 1 if there is a mild affinity or 2 if there is a strong affinity.

If the chat room is being used for a lecture, the lecturer is audibly heard by all participants. In addition, the lecturer's words are converted to text and displayed in the text box.

A subgroup of avatars 202 in the chat room can agree to hold a side chat. If the chat room is using a hosted mode protocol, side chats are permitted only if the host has authorized them. The participants in a side chat in which the viewing participant is involved are shown to the viewing participant as a separate group in the conversation box to the right of the main chat group. The viewing participant 203 is shown facing this group rather than the main chat group. The host may or may not be a participant in a side chat. Side chats can use either the chat group or the instant messaging protocol.

If there are too many people in the group or subgroup to fit in conversation box 201, the viewing participant 203 can select the other participants 202 which he or she would like to see according to several criteria, such as:
those included in a list provided by the viewing avatar.
those expressing certain emotions.
only those in the viewing avatars subgroup.
always show the speaker.
any combination of the above.

Alternatively, the conversation box 201 can be fragmented so that sub-groups in which the avatar is not a participant can be broken off and represented differently.

Emotion pane 206 allows the viewing participant to express an emotion through his or her avatar 203. Each avatar is designed to express the emotions that can be commanded via this pane, either through facial expressions, gestures, or both. Emotion expressions may be different depending upon whether the viewing participant is speaking or listening.

Picture area 207 allows users to present graphical material. This material can include videos, photographs, and drawings. In addition, it can be used as a whiteboard for users to draw pictures and to annotate or highlight elements of pictures and photographs.

Text entry box 208 is used by users to enter their contributions to a discussion. As in standard IM messaging, as soon as the user enters a carriage return, the text is sent for display on the client systems of the other users engaged in the chat room.

Text box 209 is used to show the text of conversations. The main chat room conversation is shown, as well as the conversation of the subgroup, if any, in which the avatar is participating. Indentation and color are used to distinguish between the main conversation and the conversation of the participant's subgroup, if any.

Chat control panel 210 controls the order of the speakers in chat mode.

Record button 211 is used to record chat room conversations and the lecture, if any, as well as the contents of the picture area.

Wizard button 212 allows the user to review the data in his database.

Test button 213 displays a quiz that will give a lecturer instant feedback on the progress of his group.

Notes button 214 pops up a page for the avatar to take notes.

Question button 215 is used to indicate that the user has a question or wants to make a comment; in response, the light bulb is shown over the user's avatar. Depending upon the conversation protocol being used, this indication may be host-to-avatar, avatar-to-host, or (in chat mode) avatar-to-avatar.

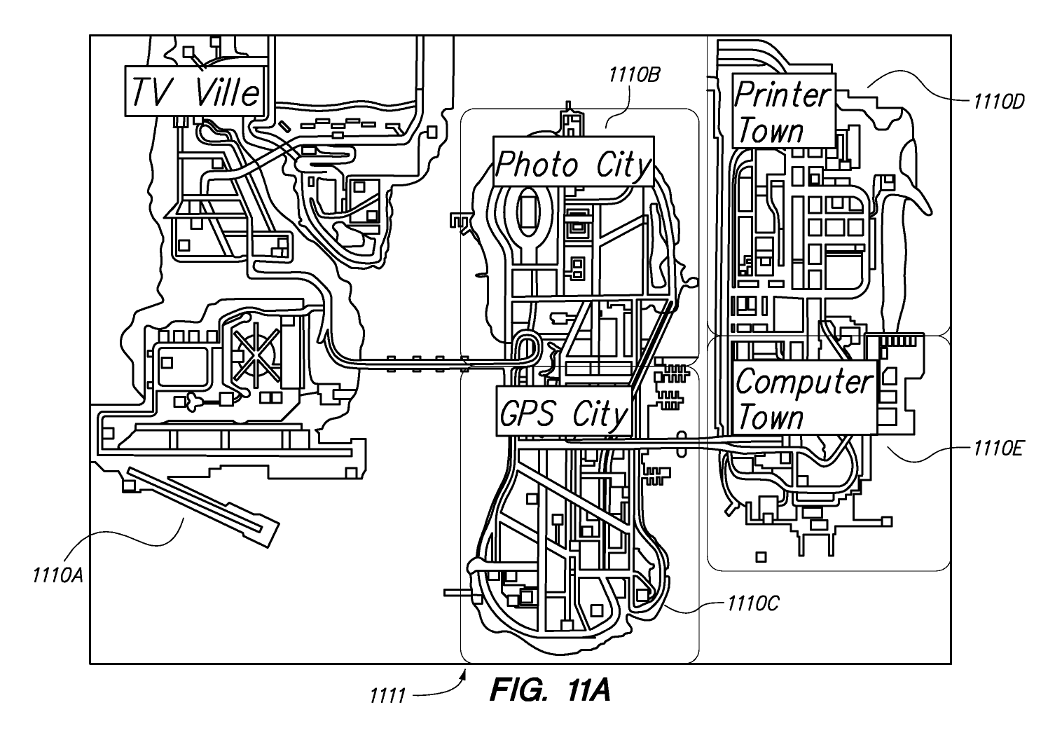

Referring now to FIG. 10, there is shown another embodiment of a chat room display 1000. Here, a photograph 1001 is shown instead of an avatar. In one embodiment, audio can be provided; control buttons 1003 are included for audio. The user can participate both in a central conversation and side conversations simultaneously by boxes 1004 and 1005, respectively. He or she can type in box 1006 to send a text communication. The user is able to integrate gestures and facial expressions by clicking on buttons 1002, and can specify eye movements via menu 1007 and context via menu 1008.

In one embodiment, the user can create reaction behaviors, and the avatars themselves provide the user with what seem to be the likely responses for a given situation, thereby reducing search effort and user clicks. In short, the avatars can be taught about the user and about likely responses, or even pro tem responses, by situation.

In one embodiment, the client provides a full three-dimensional view of a virtual world, with cities, buildings, characters, and other avatars. In one embodiment, the three-dimensional viewer is built with well-known technology used in gaming environments, allowing for lifelike graphics including advanced texture mapping, shadows, light, and real physics.

In one embodiment, the present invention uses a three-dimensional world engine, a spatial database that contains three-dimensional objects with specific attributes, and a real time spatial engine that keeps track of the spatial position and attributes of all the contained objects.

The visual representation of the environment can match a real-life type landscape. This is accomplished by using the three-dimensional objects to represent buildings, cities, countries, and the like.

The three-dimensional world engine keeps track of positions of objects in space, and updates clients with any changes in its environment based on the user's view of the world.

In one embodiment, different users can have different views of the environment. The three-dimensional world engine checks the user's affinity with proximate users and privacy setting to build an environment based on that information. In this manner, servers can be split into shards or realms, and individual users need only see what is appropriate for them to see. Conversation

Modes

In one embodiment, the present invention supports several participant conversation modes, or protocols, suitable for a range of activities, from lectures to group meetings to socializing.

Chat Groups. Chat groups provide a means for several participants to collaborate in a common discussion in a controlled manner. In one embodiment, only one participant, designated as the current speaker, can speak at any one time. The role of the current speaker passes from one participant to another in the chat group according to a specified set of rules. A chat group may include all of the avatars in a group, or it may include only a subset of avatars who have agreed to engage in a side chat.

In one embodiment, the chat group protocol operates in a manner analogous to a microphone which is passed from one speaker to the next under the control of the current speaker. The current speaker may speak as long as he or she wishes and then may pass the microphone to another participant, who becomes the current speaker. When that person finishes, he or she determines who will speak next.

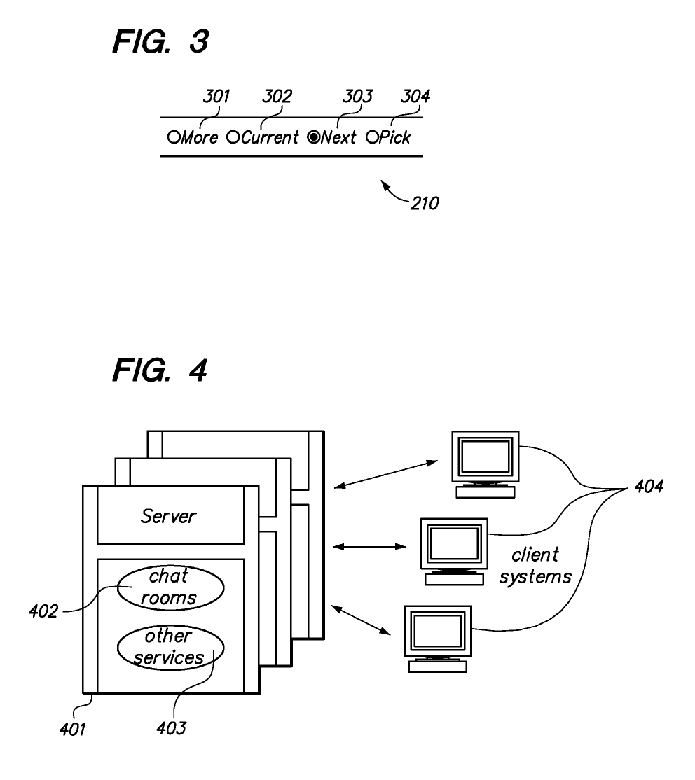

A chat begins with one of the participants acting as the current speaker. He or she controls the chat via the chat group radio buttons in chat control panel 210, shown in greater detail in FIG. 3. The chat group buttons provide the following functions:
More 301: Chatting is done via text entry. When the current speaker has typed a sentence or two, he or she presses the Return key to send the text. By keeping the More button selected, he or she maintains possession of the microphone and can type additional text.
Current 302: Should the current speaker select the Current button, the microphone passes to the last participant to whom he or she was talking. This participant now becomes the current speaker. He or she can speak as along as he wishes by keeping the More button 301 depressed. He or she can then select Current 302 to return to the previous speaker. This is useful to continue a conversation between two participants. Alternatively, the speaker can pass the microphone on via the Pick 304 or Next buttons 303 described next.
Pick 304: The current speaker chooses the next person to have the microphone. That person now has control of the conversation via the chat control buttons.
Next 303: The current speaker relinquishes control of the conversation. The participant who has been waiting in line the longest will get the microphone and will become the next current speaker.

Instant Messaging (IM). Instant messaging is a known protocol for people to converse with each other in real time over a network such as the Internet. With instant messaging, any participant can speak (that is, type) at any time to all other participants. However, instant messaging can be a very inefficient method for communication within a group of more than two people, since many people may be speaking at the same time.

Hosted Mode. A lecture is a type of hosted conversation in which the lecturer is the host. During a lecture, the host is in absolute control of the group. He can enable the chat group and instant messaging interaction capabilities described above so that the other avatars can engage in side chats during the lecture. Unless another mode is allowed, no avatar may speak unless he or she is first recognized by the host.

The host uses the chat control buttons in control panel 210 to control the group. In hosted mode, the microphone always returns to the host. An avatar who is not the host cannot pass the microphone to another avatar.

A lecture may be delivered in audio as well as text mode displayed in the text box. This allows the lecture text to be recorded so that it can be searched for key words later.

In one embodiment, questions and comments, which are entered by an avatar in his text entry box, show as text in the text box. Conversations between an avatar and the host or between an avatar and other avatars are indented and are shown in a different color to help distinguish them from the lecture in the text box. Because the lecture is delivered in audio and avatar conversations are text only, avatars can (with the permission of the lecturer) have side chats and still listen unimpeded to the lecture.

Uses of Conversation Modes

The various conversation modes can be used in a variety of ways. Examples appear below.

Lectures. A lecturer can lecture a group of avatars without interruption. The avatars hear the lecture and can read or search the lecture text that is generated as the lecturer speaks. Avatars may ask questions or make comments as permitted by the lecturer.

Hosted Discussions. In a hosted discussion, the discussion is controlled by a host. If a topic of general interest is raised by an avatar as a question or as a comment, the host can switch to chat mode to allow a general discussion of the topic. When the host wishes to end the discussion, he or she will return to hosted mode.

Private Questions. In one embodiment, the invention provides the facility to allow a question to be asked privately. In this case, only the instructor (or more generally the host) sees the question in his or her text box. He or she can deal with it in any way he wants. For instance, he or she can answer it as an anonymous question. Alternatively, he or she can arrange to see the questioner after the meeting to clarify the confusing point.

This method has the advantage of reducing the social risk of asking questions and provides an opportunity for an instructor to strengthen his or her relationship with the student.

Side Chats. A subgroup of avatars in a chat room can agree to have a side chat. It the main conversation is in hosted mode, the host must have specifically allowed side chats. To create a side chat, an avatar may invite other avatars to join the side chat, which may use either chat mode or instant messaging as specified by the inviting avatar. The participants in a side chat will be shown as a group separate from the main group in the conversation box. Each participant in a side chat will see his or her avatar facing the other participants in the discussion.

In one embodiment, the side chat is text only. During the side chat, the main group conversation continues. So far as the side chat itself is concerned, only the participants in the side chat see the text messages comprising the discussion. These messages are shown in the text box interleaved with the main group discussion text. The side chat text is indented and shown in a different color to quickly distinguish it from the main group conversation.

In one embodiment, the host may “listen in” on one or more side chats by having the text of those discussions show in his text box. In this way, he can control any unwarranted side discussions. This is especially useful in a classroom environment.

Working Groups. In a classroom environment or in a hosted group meeting, the host can break up the group into separate subgroups working on assigned tasks. The host determines whether these subgroups will use the chat or IM protocol. Each viewing participant sees the other participants in his or her subgroup in the conversation pane. The instructor may join any group at any time for as long as desired.

Private Chat Rooms. Some chat rooms may be open to any participant who wants to join the group. However, in other cases, the chat room may be limited to avatars that hold certain attributes. For instance, a chat room may be limited to only graduates of a particular university or only to avatars that have expressed a particular interest.

Conversations in private chat rooms are displayed to the participants in the same way as in a normal chat room, as discussed above.

Recording

In one embodiment, a user can record current chat room activity locally on his or her client system by depressing Record button 211. If a lecture is in progress, the text of the lecture is recorded along with any lecturer/avatar interaction, such as questions, answers, and commentary. In addition, whiteboard activity may be recorded. In one embodiment, side chats occurring during the lecture or general conversation will not be recorded.

In group settings, the entire textual conversation and whiteboard activity of the group in which the avatar is a participant are recorded. For work groups established by an instructor, the instructor may record the conversations of any or all groups, whether he is a participant or not. For groups set up by avatars, the conversations of the group are private and available only to the participants.

The recording of any session can be made available for offline playback at any time, even if the client system is not currently connected to the server. Keyword search facilities can be provided for locating specific material.

Chat Room Architecture

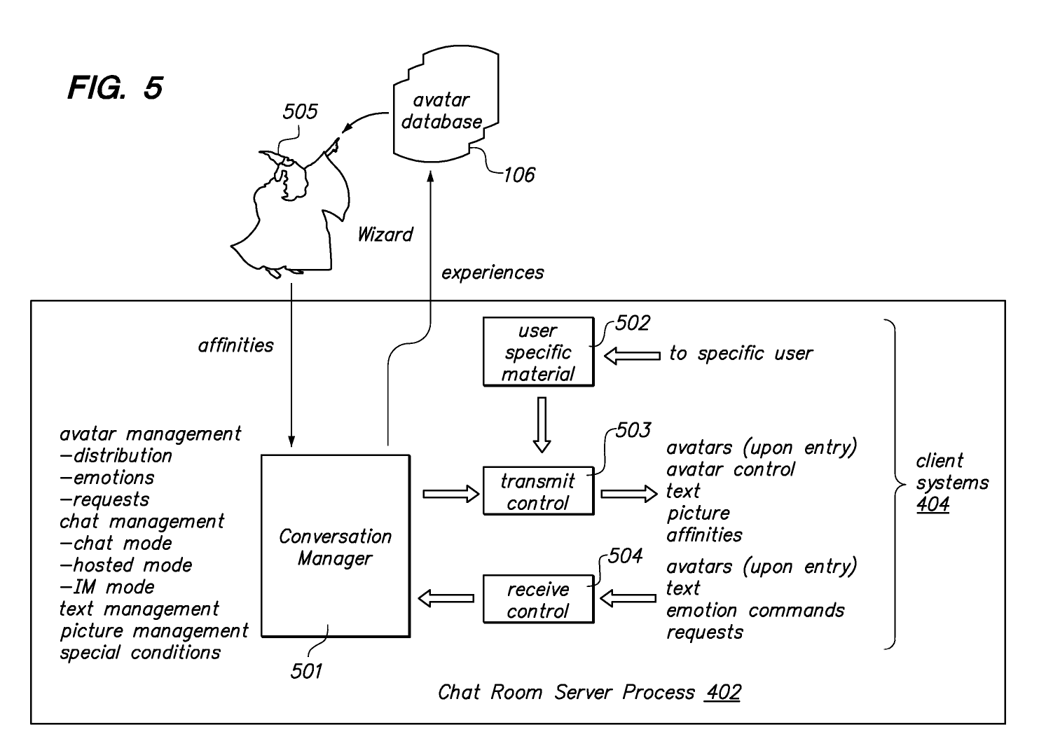

Referring now to FIG. 4, there is shown an architecture for implementing chat rooms according to one embodiment of the present invention.

In one embodiment, the chat rooms of the present invention are implemented as a server process 402 running on a central server system 401. There is a separate process 402 for each current chat room. There may be multiple server systems 401, each running multiple chat room server processes 402 as well as processes 403 supporting other services. In one embodiment, servers 401 are distributed in a grid-like configuration.

The users sit at their PC client systems 404. Each client system 404 has a copy of the client side of the chat room software. The client systems 404 connect to the chat room process that is managing their particular chat room. Connection can be accomplished via any known network connection technique over a local network or the Internet.

In one embodiment, the present invention is implemented using:
a client component distributed through the Internet and installed on the customer's computer, allowing the client to navigate and interact; and
a server component located in a hosting facility, for receiving connections from clients and providing different applications and services to the client software.

The client and server components will be described in turn.

Chat Room Server Process

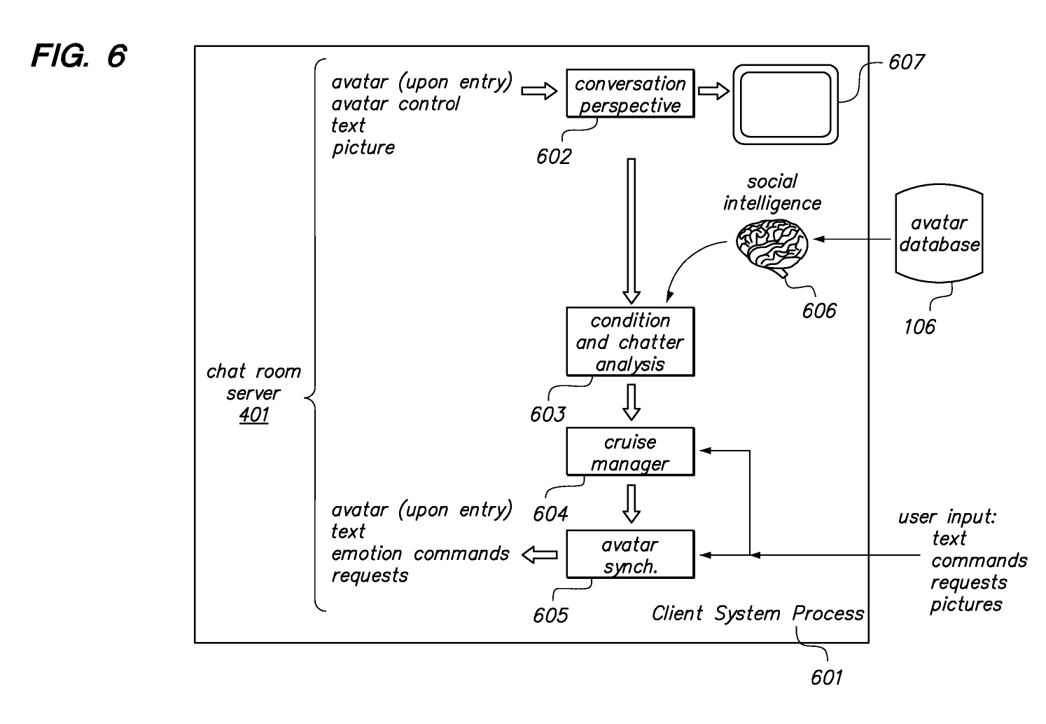

Referring now to FIG. 5, there is shown a block diagram depicting operation of a chat room server process 402 according to one embodiment.

In one embodiment, a chat room server process 402 is spawned whenever a new chat room is opened. That process is responsible for managing that one chat room.

Conversation service 501 is responsible for coordinating all chat room activity with client systems 404. These tasks include, for example:
Storing the graphical representation of an avatar when it enters the chat room.
Sending the graphical representations of all avatars in the chat room to a client system 404 when that system first logs on.
Sending the graphical representation of a new avatar joining the chat room to all client systems 404 currently logged on.
Receiving depiction commands from a user or from Wizard 505 and relaying that command to all client systems 404.
Receiving and processing requests from users such as the request to speak.
Receiving text from users and forwarding that text to all client systems 404.
Receiving affinity indications from Wizard 505 (if it is linked to the chat room) and forwarding these to the appropriate client systems.
Managing the chat protocols (chat mode, hosted mode, IM mode).
Receiving requests for side chats and then managing those side chats.
Notifying all client systems 404 of each group or subgroup as to the current speaker.
Sending the audio of a lecture along with the lecture text to client systems 404.
Managing the contents of the picture pane and sending this information to all client systems 404.
Updating the user databases 106 with the details of conversations and experiences.
Managing special conditions.

Conversation service 501 is in charge of managing avatar reactions. In one embodiment, a message moving from one user to another goes through an avatar service at the conversation server. The conversation service 501 looks at the message, analyzes it against the affinity of the people in the conversation and the users' databases, and determines an appropriate reaction.

For example, one basic behavior is that an avatar generally looks at a speaker. Based on observed behaviors of another avatar, it may look at the other avatar and, for example, smile automatically.

As described above, conversations can have multiple modes and are driven by the server. A user starting a conversation can select a desired mode to be used; the server then enforces the rules associated with the selected mode.

In one embodiment, an application programming interface (API) can be provided for the conversation server and/or the client, so that third-party developers can create their own applications that interface with the functionality of the present invention.

Transmit Control process 503 is responsible for sending information to client systems 404. This includes the initial upload of avatar images to client systems 404, avatar commands to control avatar reactions, speaker positions to allow the avatars to face the speaker, text streams as entered by the users, and pictures for the picture pane.

In one embodiment, Transmit Control process 503 monitors the backlog of data awaiting transfer to each client system 404. If the communication channel to a client system 404 is running slow and data is queuing for that client system 404, the Transmit Control process 503 adjusts the transmission parameters so as to allow the client system 404 to keep up.

Receive Control process 504 processes received information from several sources. The primary source of input for Conversation Manager 501 is client system 404. Avatar representations are sent to chat room server process 402 so that they can be forwarded to the other client systems 404. The chat room server receives text entered by each user from his or her client system 404 as well as lecture audio and picture information, which is forwarded to other client systems 404. Emotion commands and requests for recognition are also received from client system 404.

Conversation Manager 501 can receive input that is destined to go to a particular client system 404. For instance, this may be a private teacher/student communication. That information will be sent only to the designated recipient. This type of input is indicated in FIG. 5 as user specific material 502.

Wizard 505 works in the background with avatar databases 106, and can provide inputs that may affect the actions of avatars. For example, Wizard 505 generates affinity indications as it searches for affinities according to techniques described above.

Client System Process 601

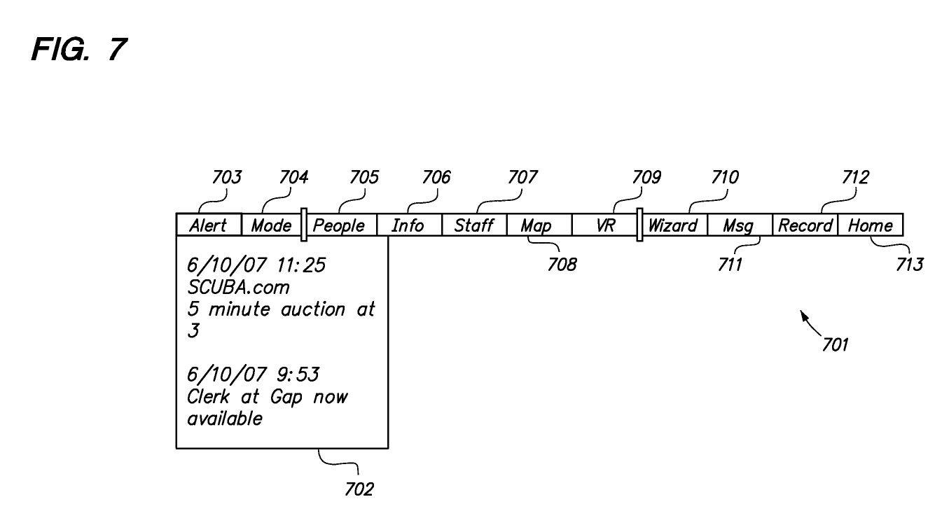

Referring now to FIG. 6, there is shown a block diagram depicting operation of a client system process 601 running on client system 404 according to one embodiment.

Each client system 404 has a process 601 that supports the client side of the chat room.

Conversation Perspective module 602 provides the following functions:
It receives the pictorial representations for each avatar currently in a chat room when the user enters that chat room.
It receives the pictorial representations for each avatar.
It arranges the avatars in the conversation box, with the viewing participant under the box looking at the other participants.
It positions the avatars to reflect the perspective of the user. For example, it may monitor the current speaker based on information from the chat room server 401 and position each avatar to look at the speaker. It also positions the speaker indicator (the green star) over the speaking avatar.
It displays the request-for recognition indicator (the light bulb) over avatars making such requests.
It receives depiction data (such as gestures, emotions, and the like) of other avatars and uses this data to generate a reaction.
It receives text entered by the various avatars and displays this in the text box.
It receives lecture audio and plays it on the client system.
It receives pictures and picture commands from the users and renders these in the picture pane.

Output from Conversation Perspective module 602 is rendered on screen 607.

Condition and Chatter Analysis module 603 monitors the text streams, avatar emotions, and other indicators to determine if there is a warranted automatic response by the avatar. It also receives inputs from its own social intelligence logic 606 based on entries in avatar database 106 that might also trigger an automatic response.

If an automatic response is warranted, a command is sent to Cruise Manager 604 to tell it to generate the appropriate response.

Cruise Manager 604 receives commands from Condition and Chatter Analysis module 603 for a complex reaction. It also receives such commands from the local user. It generates the sequence of avatar depictions required to implement those responses and sends them to Avatar Synchronization module 605 for forwarding to Chat Room Server 401.

Avatar Synchronization module 605 is responsible for all communication from the client system process 601 to chat room server 401. This includes text generated by the local user, emotion commands, requests for recognition, and material and commands for the picture pane.

Avatar Synchronization module 605 synchronizes the avatar's responses to its environment. For instance, if its avatar is mimicking lip sync, it determines the amount of time that the lip sync should continue depending upon the text that is being sent. If there is a cruise program response to the actions of another avatar, Avatar Synchronization module 605 determines the duration of its response to be consistent with the actions of the other avatar.

Operation of Enhanced Chat Rooms

A user logs on. The avatar that the user has selected for this particular virtual environment is activated. Alternatively, the user can choose to use a temporary avatar. By doing so, he or she can enter totally anonymously as a tourist.

In one embodiment, the user can specify a “buddy list” of those users he or she considers close friends. Following login, he or she is presented with a list of “buddies” who are currently online. The user can then contact them if he or she wishes. If he or she is informed by a buddy as to which group the buddy is in, the user's avatar can join that group if allowed (i.e., either the group is public or the user's avatar has the attributes to join a private group). Alternatively, the user can join a group of his or her choice.

When an avatar joins a group in the chat room, chat room server process 402 informs the other client systems 404 in the group of the presence of the new avatar. The Conversation Perspective module 602 at each client system 404 updates its conversation box 201 to show the new avatar in the group. Chat room server process 402 informs the Conversation Manager 501 about the composition of the group so that it can construct a group conversation box for the joining user.

At this point, the user's avatar has joined a group; and social interaction or education proceeds as described above.

Chat Room Uses

There are many uses for a chat room according to the present invention. Some uses are better suited to a structured mode, while others are better suited to an unstructured mode. In a structured mode, there is a set of rules for avatar behavior. In an unstructured mode, avatars can behave as they wish. Examples of chat room uses appear below.

Social Meetings. Avatars can meet in groups in a chat room for socializing or for meetings on a specific topic. These groups can be open, or they can be limited to residents or to confirmed residents of a particular community.

An avatar can see which groups in which it has expressed an interest are currently open and who is in attendance. Using this information, the user can decide which group he would like to join.

An avatar can control its interactions with other avatars. Looking for affinities, the avatar can search through the avatars in attendance. An affinity might be determined by previous acquaintance, interests, or any other specified attribute. Avatars with which it has an affinity will be identified. Conversely, it can be approached by other avatars which have determined that they have an affinity with this avatar, and it can respond if so desired.

Corporate Meetings. A chat room can be set up for corporate meetings. The picture area can be used if presentations are to be made. Lectures can be accommodated.

Focus Groups. Similarly, chat rooms can be set up for focus groups. These may be permanent chat rooms, and attendance may be limited to citizens interested in the focus group topic.

Parties. The Wizard can organize “parties,” which are group meetings of avatars that it deems to have common interests per their affinities. It can send invitations to those avatars to attend the party. If an avatar receives such an invitation, that avatar can be assured that there will be one or more avatars at the party that it would like to meet.

Distance Learning. Chat rooms can be used for classroom purposes. Student avatars can congregate in a classroom to attend a lecture, have side chats among themselves, be broken into work groups, and/or meet after class to discuss the material.

Interactive Shopping. If a user visits an online store which participates in services as provided by the present invention, the user can use the functionality of the present invention to request a clerk to help him. Store clerks are live users sitting at a store client system. The user is notified when a clerk is available. At that point, he can engage in a chat with the clerk in a chat room to get whatever help is needed.

Shopping Services. Professional shoppers can put together packages of web pages that contain quality items for a specific purpose. These can be searched by a user based on various parameters and can take the user to specific pages on pertinent sites.

Online stores can cooperate with the professional shoppers creating the lists to give them the required information and to keep that information current. In return, the stores can be granted access to the public data of each shopping avatar, which can be a tremendous source for instant marketing and market research. The stores may compensate the professional shopper with commissions.

Shopping Tours. Tours can be organized for avatars at a virtual store or mall. The tour is conducted, for example, by an expert guide. Each avatar is presented with items of interest in the stores or in the store windows based on the interests expressed in its database. The avatars on the shopping tour can discuss with the expert shopping guide and with each other the items being shown and can meet with a product specialist to obtain additional information.

Games. An avatar can learn to play games and to improve its game-playing skills over time. One game of interest is a database contest. Users are judged based on how well they could answer a series of personal questions based on avatar database contents. Valuable prizes can be offered to the winners. This encourages users to make their databases as complete as possible, thus increasing the value of the avatar databases.

Toolbar

In one embodiment, a toolbar is provided as a browser add-in for users to access various services. The toolbar provides a user interface for accessing particularly functionality associated with the current environment.

A toolbar service tracks the user's activities on the Web, allowing the users to see and interact with other users on a given Web page. The toolbar service also enables sites to provide special services. The toolbar also provides information about the site where appropriate.

In addition, in one embodiment a range of services is offered to merchants based on the personal information that is made available as a result of Wizard functionality.

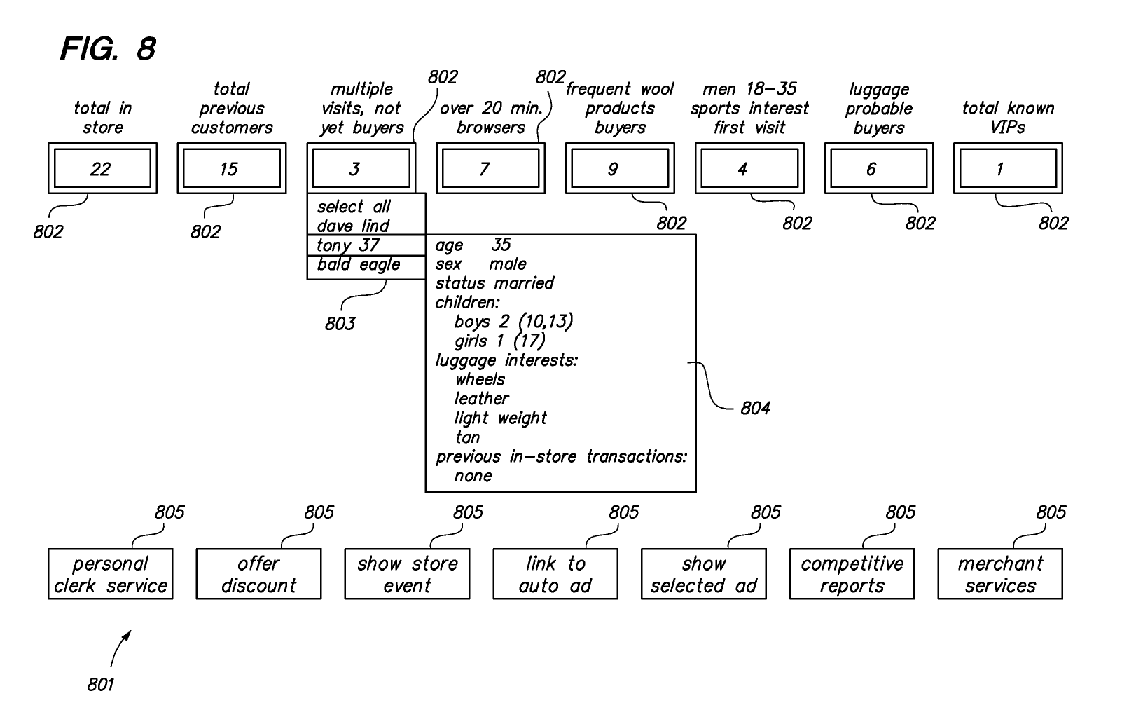

Referring now to FIG. 7, there is shown an example of toolbar 701 according to one embodiment of the present invention. In one embodiment, toolbar 701 runs as an add-in to the user's browser. The user downloads it from a web site when he or she registers for services. Toolbar 701 is installed in the browser along with the other browser toolbars. As with other toolbars, it can be turned on and off via the View menu or equivalent toolbar control.

In certain situations, a side pane 702 associated with one or more of the toolbar functions may open below toolbar 701 to show additional information. Side pane 702 can be opened and closed via its corresponding toolbar button.

In one embodiment, toolbar 701 includes various buttons as shown in FIG. 7, although many different arrangements are possible.

Alert button 703 indicates the availability now or at some later scheduled time of an interactive experience. For instance, it may inform the user of the availability of a store clerk, of a friend, of an auction, of a class, or of an interactive service. In one embodiment, when such availability is announced, Alert button 703 turns red and flashes. Alert side pane 702 opens when Alert button 703 is clicked. Alert side pane 702 shows outstanding alerts and the highlighted new alert that triggered the notification, as shown in the example of FIG. 7.

The user can delete an alert message from Alert side pane 702 by selecting it and pressing the Delete key. Alert side pane 702 can be opened and closed by clicking Alert button 703.

Typical alerts include special events and the availability of online services.

Mode button 704 turns the Wizard on and off. If the user turns the Wizard off, the Wizard does not provide affinity computations or provide the site with data about the user. This may limit user's ability to establish affinity with (and see) new users. The user's avatar may participate in social interactions. However, without the Wizard services, the user's ability to interact with new people is limited, as new people are unable to use the Wizard to establish the user's credentials.

If the user turns the Wizard on, then he can see affinity levels with other avatars and can participate in all Wizard services.

People button 705 provides access to a display showing which avatars are currently online that pass the user's privacy test. People button 705 opens a side pane (not shown) showing a list or the depictions of these avatars. Those avatars in the pane that share an affinity with the user are noted by an affinity indicator (1 is a mild affinity, 2 is a strong affinity). By hovering over that avatar, the user can see the attributes leading to the affinity. By clicking on the avatar, the user can send a message to that avatar. This could be, for instance, a query as to where the avatar is currently visiting, or it could be an invitation to meet. If the avatar's user is currently visiting a site, he or she may or may not be in the chat room. If he or she is in the chat room, other users may enter the chat room to interact with him or her. If not, other users may him or her to join a room for a chat. Based on where certain avatars are, the user can decide to join them in a currently active group.

Info button 706 provides access to an online wiki. A side pane (not shown) opens; data is presented concerning the current site or wiki. If desired, the user can specify an Internet site and can see information about the site or a related wiki.

If the user is in an online store and wants help from a store clerk, he or she clicks on Staff button 707. If a clerk is available, a chat room will be opened for the user and the clerk, ready for conversation. The clerk can use the picture pane in the chat room to show images of products in which the user is interested. If a clerk is not immediately available, then the user can go about other business. When a clerk does become available, the user is notified via Alert pane 702.

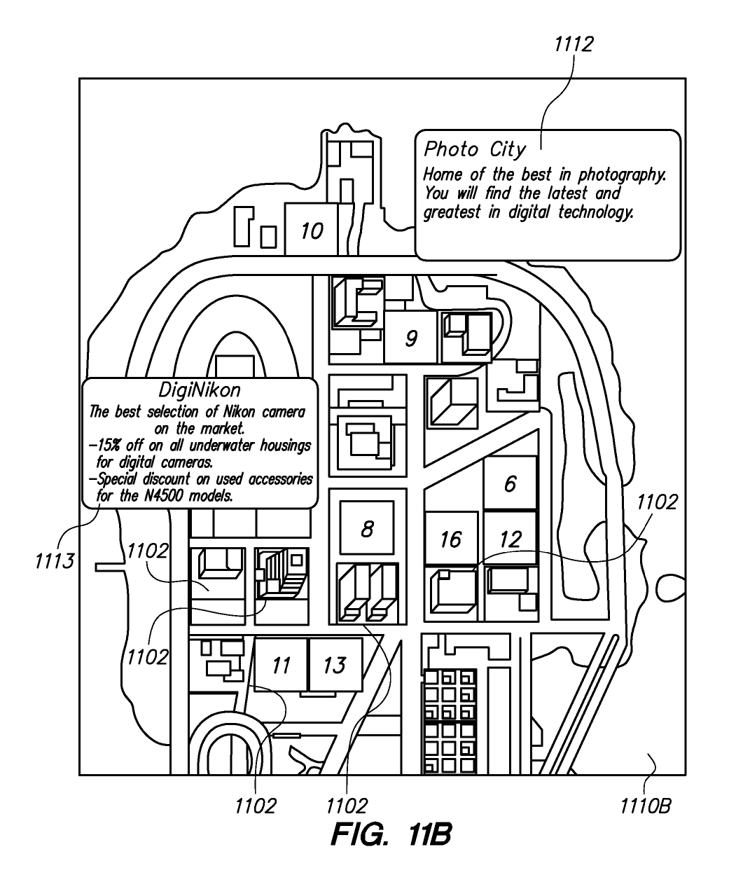

Map button 708 provides access to a two-dimensional of a virtual city showing participating online stores. URL addresses and features can thereby be converted to a spatial metaphor, making the key aspects of the site visual. Referring now to FIGS. 11A through 11C, there are shown examples of virtual city displays. In FIG. 11A, general map view 1111 is provided. Various districts 1110A through 1110E are included; each district can be color-coded if desired. Hovering over a district 1110A through 1110E can cause more information to be displayed, such as types of products sold, popularity, and the like. Clicking on a district 1110A through 1110E causes the display to zoom down to the next level.

In FIG. 11B, a detailed map view showing district 1110B is shown. Description 1112 of district 1110B is included. In this example, district 1110B is associated with photography; thus, the stores that appear in district 1110B tend to sell photography-related items. Various stores 1102 are shown, represented as buildings within district 1110B. The user can cause the cursor to hover of a store 1102, causing detailed description 1113 to be displayed. Detailed description 1113 can include discounts, special offers, and the like. Detailed description 1113 can be tailored to the individual interests of the user. For example, if the user is known to have a strong interest in scuba diving and is known to own a particular model of camera, detailed description 1113 can display information about a waterproof housing for that specific camera model available at the store 1102 over which the cursor is hovering.

FIG. 11C shows a more detailed street-level depiction of the virtual environment. Here, streets 1101A, 1101B are represented. In one embodiment, stores 1102, 1103 are organized by neighborhood, where each neighborhood is associated with a certain product type. For example, in FIG. 11, book street 1101A might be a place to shop for books. The user can enter a store 1102, 1103 by clicking on it. In one embodiment, online stores 1102, 1103 rent space to be shown in one or more neighborhoods.

Various types of information can be shown on the virtual city display. In one embodiment, stores 1102, 1103 are color-coded to indicate that they are linked to Wizard functionality. A dotted perimeter can indicate clerk service at a store. Shapes can indicate types of focus; for example, a diamond 1102 can represent a specialty store, while a rounded rectangle 1103 can represent a variety store. Additional icons can indicate further functionality. For example, a star 1106 can indicate presence of a chat room. A bulls-eye 1105 can indicate discounts. A wiki rating can be included, for example as a numeral on a store 1102, 1103.

The present invention thus provides a way to display online store information in a virtual, navigable environment using the metaphor of a city with districts and streets. One skilled in the art will recognize that many other features and layouts can be included.

VR (Virtual Reality) button 709 provides access to a three-dimensional virtual world, where the user can wander down streets looking into store windows. In each window, he or she sees only items that the Wizard thinks matches his or her interests and preferences. If the user sees something he or she likes, he or she can enter that store and use its online shopping services, including all of the shopping services provided.

Wizard button 710 displays a customized report prepared by the Wizard specifically for the user. It includes current news about people, merchants, and events relating to the affinities that the Wizard calculates. The information is derived from a variety of sources such as online newspapers, magazines, and newsletters. It can also include marketing messages broadcast to a group of avatars with specified attributes supplied by the advertising merchants. The user can train this service by rating each item. For instance, he or she can indicate that information on a specific topic is of great interest or is of little interest. Alternatively, he or she can instruct the Wizard to not report on a topic in the future.

Messages button 711 provides access to messages received from other avatars. These messages may be, for instance, personal messages from other avatars, or expressions of interest based on affinity calculations. When a new message is received, Message button 711 is highlighted. Messages can be responded to and can be deleted by selecting them and using the Delete key.

Record button 712 is used by expert shoppers to create a list of online stores of interest. As the expert shopper visits a store, he or she can record comments about the store. Stores can be put together into a list of URLs and edited. This list will be used by the expert shopper to provide user services. The expert shopper may get commissions from the stores for sales made to avatars which it is serving.

Home button 713 takes the user to a home site where he or she may update his database and perform other administrative tasks.

Merchant Services

In one embodiment, the present invention provides various merchant services related to the chat room and avatar functionality described above. These services may be made available, for example, via a website. By logging on to this Web site, merchants can:
monitor the avatars that are currently in their store.
provide interactive clerk services via their clerk avatars to users for a variety of purposes.
display various store promotions such as auctions, discount offers, and events.
show ads tailored to the shoppers interests either automatically or manually.
conduct special events like classes, auctions, and the like.

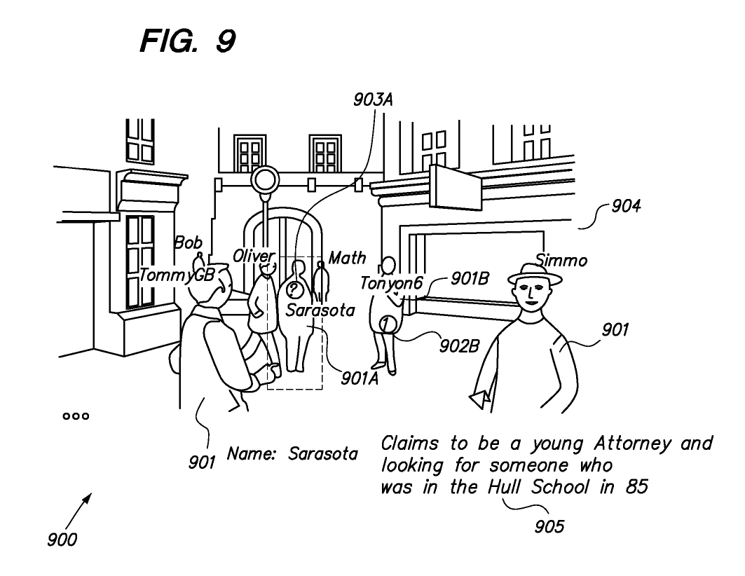

Referring now to FIG. 8, there is shown an example of a website display 801 according to one embodiment.

Monitor In-Store Avatars

In one embodiment, the website provides a list of all avatars currently in an online store. The merchant can view this list through a set of queries. For instance, the merchant might want to know the total number of avatars currently in the store, the number of men looking at luggage, the number of women looking at shoes, and the number of young adults in the sports department. Examples of avatar counts 802 in various categories are shown in FIG. 8.

The counts 802 of the number of avatars satisfying each query are displayed on the merchant's browser. This count is kept updated as avatars enter and leave the store.

By clicking on a count 802, the merchant can view a list 803 of all avatar names that satisfy particular conditions. By clicking on a particular avatar, the merchant can view the pertinent public data 804 which that avatar has made available.

Based on this information, the merchant could take one of several actions for one or more of the avatars in a list. Various buttons 805 activate different types of actions. He or she can select a single avatar, all avatars, or selected avatars. These actions include, for example:
assigning a clerk to approach the avatar and offering help via a chat room.
offering the shopper an instant discount if he buys now or a coupon for later use.
showing the shopper upcoming store events such as auctions or special sales.
showing the shopper click-thru ads that correspond to his interests.
linking to auto ads.

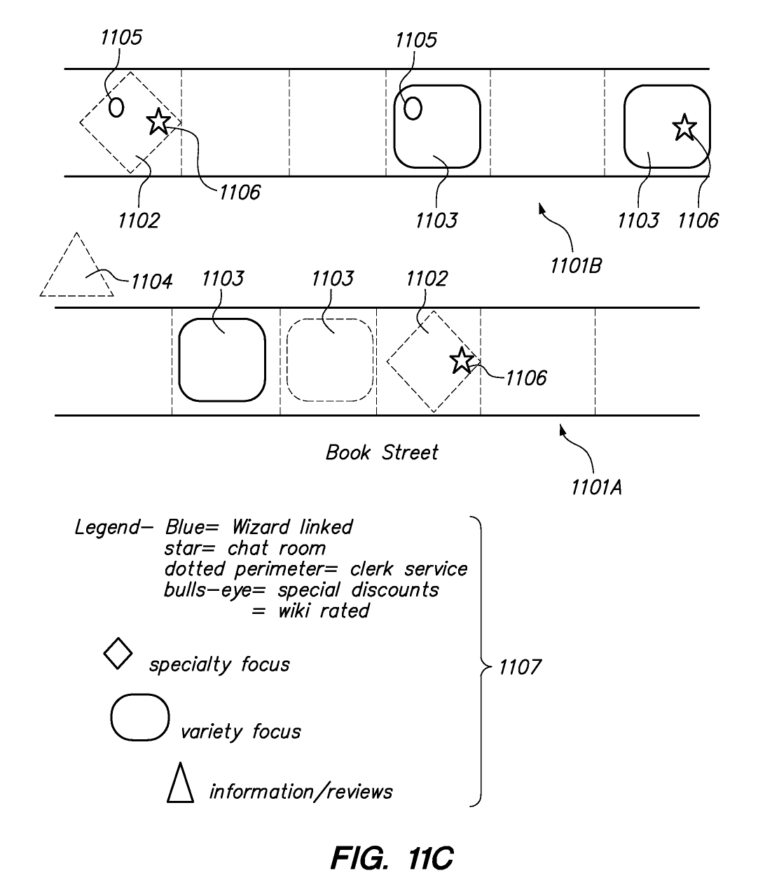

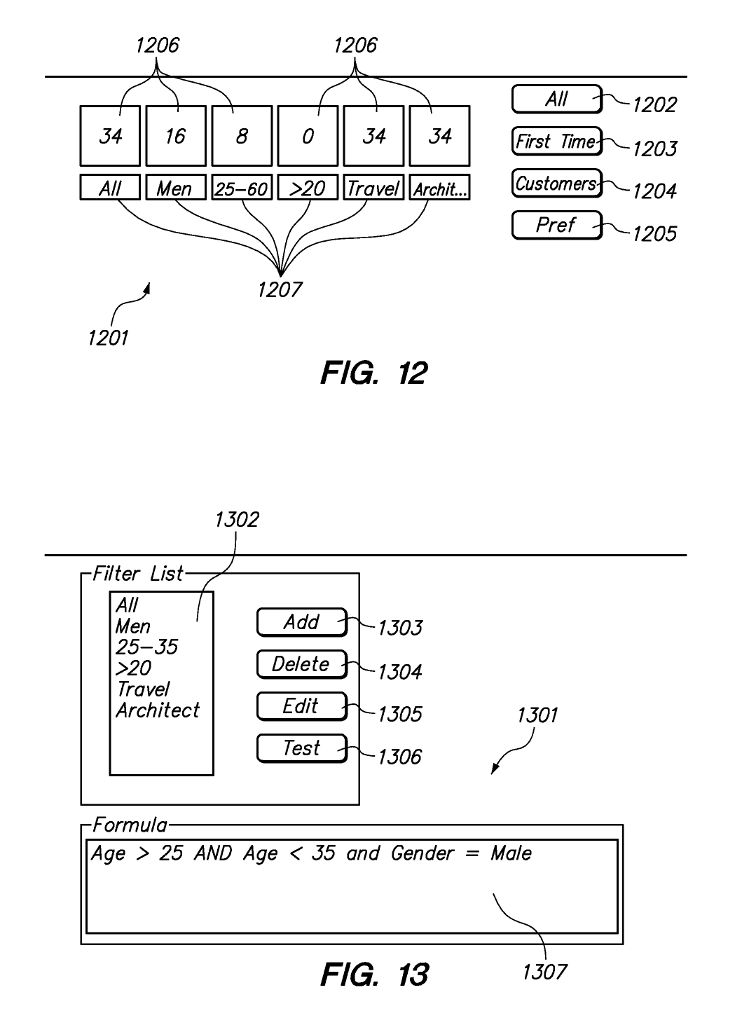

Referring now to FIG. 12, there is shown an example of a merchant monitor window 1201 according to one embodiment. This window allows a merchant to see, in real-time, information about the users visiting the merchant's website. For each category 1207, the number 1206 of visitors is shown. The merchant can specify a filtering algorithm if desired. The user can click on All button 1202 to see all users visiting the website. First Time button 1203 causes only those users who are visiting for the first time to be displayed. Customers button 1204 causes existing customers (who have purchased from this store before) to be displayed. Pref button 1205 opens monitor configuration window 1301, as shown in FIG. 13. Clicking on category box 1207 causes a list to be displayed including all website visitors matching the corresponding filter algorithm. In one embodiment, this list is a user list detail; the merchant can select the format of the displayed list. The merchant can select individual visitors from the displayed list, and specify actions to be performed with respect to the selected visitors. Clicking on a specific visitors causes a visitor detail window to be displayed showing more information on the selected visitor.

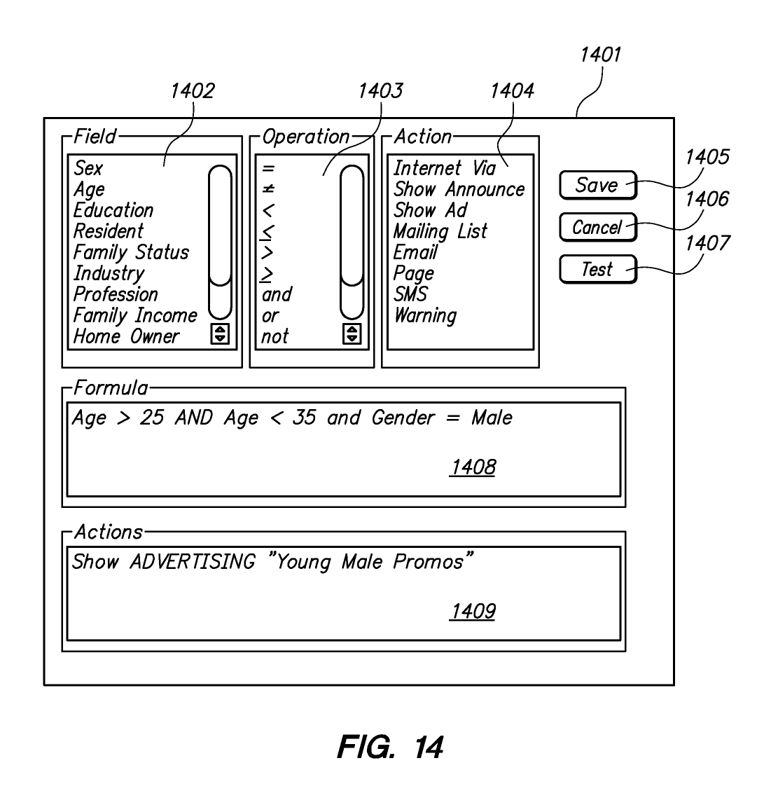

Referring now to FIG. 13, there is shown an example of merchant monitor configuration window 1301 according to one embodiment. The merchant can select a filter from list 1302. Formula 1307 for the selected filter is shown. The merchant can click on Test button 1306 to see what kind of result set would be produced by applying the selected filter. Edit button 1305 provides access to a filter editing window 1401, as shown in FIG. 14, for changing filter parameters and/or actions as desired. Add button 1303 allows the merchant to add a new filter. Delete button 1304 causes the selected filter to be deleted.

Referring now to FIG. 14, there is shown an example of filter editing window 1401 according to one embodiment. Window 1401 facilitates configuration of filter parameters (formula) 1408 and actions 1409. In one embodiment, window 1401 is shown when a merchant indicates that he or she wishes to add or edit a filter.

The merchant selects a field from field pane 1402 an operation from operation pane 1403, and a parameter. Multiple conditions can be aggregated using AND or OR operators. An action can be selected from action pane 1404. As the merchant makes selections from panes 1402, 1403, and 1404, formula 1408 and actions 1409 are updated accordingly. In one embodiment, the merchant can type in formula box 1408 and action box 1409 to further specify filter parameters and actions. In one embodiment, syntax errors can be indicated, for example by highlighting with a red underline. Save button 1405 saves the filter. Cancel 1406 cancels the filter editing operation. Test button 1407 tests the filter by showing the result set that would be displayed with the current filter parameters.

Assign Clerk

If an avatar requests the help of a clerk, an available store clerk avatar can respond when available and can enter a chat room with the user's avatar.

Approach Customer

If the merchant spots an avatar that looks like a promising customer, he can have a clerk avatar approach that customer and attempt to enter into a conversation aimed at helping and encouraging the customer to make a purchase. The avatar shopper is notified of this attempt via his Alert list.

Create Offer

The merchant can create an immediate offer to an avatar in his store based on the interests and preferences of that avatar. For instance, this might be a special discount or a coupon good for future purchases.

Send Offer

The merchant can create a marketing message, which might, for instance, be an advertisement or an offer, and send it to all avatars according to a list of attributes which the merchant specifies. The Wizard searches for avatars having these attributes and sends the message to them This message appears in the customized reports generated for the users by the Wizard and which are accessible to the users via their Wizard button.

Create Auction

The merchant may create an auction that he thinks will be attractive to selected avatars. He specifies the list of avatars to which an invitation to the auction will be sent. The list is based on avatars that have registered with the store for auctions of interest or that have visited his store and whose attributes he has accumulated.

The auction invitation appears in the Alert list of the invited avatars. The intent of this function is to support quick auctions (lasting only a few minutes). The auction will generally be used to sell multiple items of a given product. When the auction is over, the merchant can decide what price he will accept and will sell all participants that bid that much or more one of the items at that price. In this way, he can balance the number of items sold against the price for those items.

Competitive Reports

In one embodiment, the merchant can request competitive reports showing how the merchant is doing compared to other similar stores.

Merchant Services

By clicking on Merchant Services button 805, the merchant is taken to a display for managing services. For instance, it is on this screen that the merchant can construct new queries to show classes of users in his store.

### CONCLUSION

The present invention provides a mechanism by which users can use avatars in an online community to meet and socialize with people they would not meet otherwise, to have new kinds of social experience, and to find opportunities in the commercial world that would otherwise be unavailable.

The present invention facilitates such experiences by enabling and encouraging collection of extensive personal data from a large number of users. By structuring shopping, marketing, and other revenue-producing and revenue-enhancing services around this collected data, the present invention enhances online social experiences and creates the potential for significantly increased revenue streams for participating merchants and other enterprises. Specifically, merchants can use the present invention to find out more about potential customers, including personal data, experiences, interests, and preferences, and the like. This gives insight into what potential customers are looking for, what their preferences are, what their shopping histories are, and more. This closer relationship with its customer base has tremendous value to the merchant.

What is claimed is:

1. A method for collecting user information in a multi-participant online community, comprising:
recording avatar behavior in the multi-participant online community;
inferring user information from the recorded avatar behavior;
determining affinities among users from the inferred user information; and
storing the determined affinities and the user information.
